(19) United States
(12) Patent Application Publication
(10) Pub. No.: US 2014/0244784 A1
(43) Pub. Date: Aug. 28, 2014

(54) Website Impersonation System and Method

(71) Applicant: OPEN TEXT S.A., Luxembourg (LU)

(72) Inventors: Michael Gerard JASKIEWICZ, Urbandale, IA (US); Alan Benjamin BAER, Madison, WI (US); Bertrand Guy LE BESCOND DE COATPONT, Austin, TX (US); Claiborne Holt JOHNSON, III, Austin, TX (US)

(73) Assignee: Open Text S.A., Luxembourg (LU)

(21) Appl. No.: 13/781,160

(22) Filed: Feb. 28, 2013

(51) Int. Cl. H04L 29/08

(52) U.S. Cl. CPC H04L 29/0809
USPC 709/217

(57) ABSTRACT

Embodiments provide systems and methods for operating a site in multiple modes including an impersonation mode and a non-impersonation mode. In one embodiment of the non-impersonation mode of operation, a server can be configured to request visitor segments corresponding to a website visitor from a segment provider and process requests associated with the website visitor using the visitor segments associated with the website visitor (and provided by the segment provider) to generate web page files for segment dependent web pages. In one embodiment of the impersonation mode of operation, a server can be configured to process requests associated with the website visitor for segment dependent web pages using impersonated user segments specified by a user to generate the web page files.

### COPYRIGHT NOTICE

A portion of the disclosure of this patent document contains material to which a claim for copyright is made. The copyright owner has no objection to the facsimile reproduction by anyone of the patent document or the patent disclosure, as it appears in the Patent and Trademark Office patent file or records, but reserves all other copyright rights whatsoever.

### TECHNICAL FIELD

This disclosure relates to website systems and methods. More particularly, embodiments described herein relate to systems and methods for impersonating users at a website.

### BACKGROUND

Many websites provide web pages that are tailored, to some degree, to the users of the website. Any number of characteristics may be used to determine what content is returned or displayed in a particular instance of a web page. As one common example, a website may return different content to a mobile web browser than to a desktop web browser. As the number of characteristics upon which returned or displayed content is dependent grows and the number of content items that are dependent on the characteristics increases, the website becomes increasingly complex and, as a practical matter, extremely difficult to test.

### SUMMARY

An object of some embodiments disclosed herein is to significantly reduce the burden and complexity associated with testing and authoring websites. This object can be achieved by providing systems and methods that allow a visitor to use impersonated user data to test the website. A website system can operate in various modes of operations including in impersonation modes and non-impersonation modes. In a non-impersonation mode, the website system can process user requests for web pages in its normal fashion. In the impersonation mode, a user can force the website to use certain characteristics or segments when processing the visitor requests, where the characteristics or segments do not necessarily correspond to the characteristics or segments associated with the visitor. In particular, embodiments can allow a user to specify impersonated user segments to use when processing a visitors request. The website system can generate instances of web pages based on the impersonated user segments rather than the segments that would be otherwise used for the visitor. This can allow the visitor to test a website using different criteria.

One embodiment includes a system comprising a repository storing web page definitions for segment dependent web pages and a server coupled to the repository. The server can be configured to receive requests associated with a website visitor for segment dependent web pages and determine whether to operate in an impersonation mode of operation or a non-impersonation mode of the operation.

In the non-impersonation mode of operation, the server is configured to request visitor segments corresponding to the website visitor from a segment provider and process the requests associated with the website visitor using the visitor segments provided by the segment provider to generate web page files for the segment dependent web pages. The web page files can be generated based on applying a set of targeting rules to the visitor segments associated with the visitor.

In the impersonation mode of operation, the server can be configured to process the requests associated with the website visitor for the segment dependent web pages using impersonated user segments specified by a user. The web page files can be generated based on applying the set of targeting rules to the impersonated user segments.

The server can be configured to maintain a set of session information associated with the website visitor comprising a set of visitor data and a set of impersonated user data. The visitor data can comprise information about the website visitor and the set of impersonated user data can comprise a set of impersonated user segments.

The server can further store visitor profiles for website visitors and store impersonated user profiles independent of the visitor profiles. The server can load at least a portion of the visitor data from a visitor profile associated with the website visitor and load at least a portion of the impersonated user data from a selected impersonated user profile.

The server can be further configured to allow the website visitor to select an impersonated user profile. The server can determine a selected impersonated user profile selected by the website visitor and update session information associated with the website visitor with a set of impersonated user segments corresponding to the selected impersonated user profile. In some embodiments, the server is configured to allow the website visitor to apply multiple impersonated user profiles within a context of a single session. For example, impersonated user profiles may be applied sequentially within the same session.

Another embodiment can comprise a computer program product comprising a non-transitory computer readable medium storing a set of computer instructions executable by a processor to receive requests associated with a website visitor for segment dependent web pages and determine whether to operate in an impersonation mode of operation or a non-impersonation mode of the operation.

In the non-impersonation mode of operation, the instructions can be executable to request visitor segments corresponding to the website visitor from a segment provider and process the requests associated with the website visitor for segment dependent web pages using the visitor segments provided by the segment provider. The web page files can be generated based on applying a set of targeting rules to the visitor segments associated with the visitor.

In the impersonation mode, the computer instructions can be executable to process the requests associated with the website visitor for the segment dependent web pages using impersonated user segments specified by a user (the visitor or other user). The web page files can be based on applying the set of targeting rules to the impersonated user segments.

Yet another embodiment can include a method comprising receiving requests associated with a website visitor for segment dependent web pages at a server. The method can further include determining whether to operate in an impersonation mode of operation and a non-impersonation mode of the operation.

In the non-impersonation mode of operation, the method can include requesting visitor segments corresponding to the website visitor from a segment provider and processing the requests associated with the website visitor for the segment dependent web pages using the visitor segments provided by the segment provider. Processing the requests can further comprise generating web page files for the segment dependent web pages based on applying a set of targeting rules to the visitor segments associated with the visitor.

In the impersonation mode of operation, the method can include processing the requests associated with the website visitor for the segment dependent web pages using impersonated user segments by a user. Processing the request can further comprise generating the web page files based on applying the set of targeting rules to the impersonated user segments.

Another embodiment of a system for testing a website can comprise a repository storing a web page definition for a segment dependent web page, the definition comprising a targeting rule associated the web page, and a server coupled to the repository configured to receive requests for the segment dependent web page. The server can comprise a network interface to interface with a transmission channel, a processor and a computer readable medium storing a set of computer instructions. The set of computer instructions can comprise computer instructions executable by the processor to receive a first web page request for the segment dependent web page, the first web page request associated with a website visitor, determine a target segment associated with the segment dependent web page and determine a mode of operation for processing the first web page request.

If the mode of operation is a non-impersonation mode, the computer instructions can be further executable to send a request to a segment provider to request a visitor segment associated with the request and receive the visitor segment from the segment provider. The server can generate a web page file for the segment dependent web page based on applying the targeting rule to the visitor segment received from the segment provider. If the mode of operation is an impersonation mode, the computer instructions can be further executable to determine an impersonated user segment associated with the first web page request and generate the web page file for the segment dependent web page based on applying the targeting rule to the impersonated user segment.

According to one embodiment the computer instructions can be further executable to maintain a set of session information associated with the website visitor and store visitor data in the session information. The visitor data comprising characteristics associated with the visitor. The computer executable instructions can be further executable to store impersonated user data in the session information, the impersonated user data comprising the impersonated user segment.

In the non-impersonation mode, the computer instructions can be further executable to access characteristics associated with the visitor from the visitor data in the session information and send the characteristics to the segment provider in the request to the segment provider. In the impersonation mode, the computer instructions can be further executable to access the impersonated user segment from the impersonated user data in the session information. The set of computer instructions may further comprise instructions executable to receive an updated impersonated user segment and store the updated impersonated user segment in the impersonated user data in the session information.

The set of computer instructions can further comprise instructions executable to receive a second web page request associated with the website visitor for the segment dependent web page and generate a second web page file for the segment dependent web page based on applying the targeting rule to the updated impersonated user segment. The second web page request can be processed in a context of a single website session with the first web page request.

The set of computer instructions may be further executable to determine a first set of target segment categories associated with the segment dependent web page and determine a set of impersonated user segments corresponding to target segments in the set of target segment categories, wherein the impersonated user segment is in the set of impersonated user segments. The set of computer instructions can also be executable to determine a first set of remaining target segment categories from the first set of target segments, wherein the first set of remaining target segment categories comprises target segment categories for which there is no corresponding impersonated user segment in the set of impersonated user segments. The set of computer instructions can be further executable to determine a first set of visitor segments corresponding to target segment categories in the first set of remaining target segment categories. Generating the web page file for the segment dependent web page based on applying the targeting rule to the impersonated user segment can thus include generating the web page file based on applying a set of targeting rules to the set of impersonated user segments corresponding to target segments in the set of target segment categories and to the set of visitor segments corresponding to target segment categories in the first set of remaining target segment categories.

The set of computer instructions may be further executable by the server to determine the first set of visitor segments from visitor segments in session information, determine a second set of remaining target segment categories from the first set of target segment categories, wherein the second set of remaining target segment categories comprises target segment categories for which there is no corresponding visitor segment in the first set of visitor segments, and determine a second set of visitor segments from the segment provider, the second set of visitor segments corresponding to target segment categories in the second set of remaining target segment categories. In this case generating the web page file further may include generating the web page file based on applying the set of targeting rules to the second set of visitor segments.

Another embodiment can include providing a web server module and a page generator module, wherein the page generator module is configured to operate in a non-impersonation mode of operation and an impersonation mode of operation. The web server module can receive client browser requests from client browsers and sending requests to the page generator module. The page generator module can receive a first web page request for a segment dependent web page from the web server module, the first web page request associated with a website visitor and determine a target segment associated with the segment dependent web page. The page generator module can further determine a mode of operation for processing the first web page request.

If the mode of operation is the non-impersonation mode, the page generator module can send a request to a segment provider to request a visitor segment associated with the request and receive the visitor segment from the segment provider. Additionally, the page generator module can generate a web page file for the segment dependent web page based on applying the targeting rule to the visitor segment received from the segment provider and provide the web page file to the web server module.

If the mode of operation is the impersonation mode, the page generator module can determine an impersonated user segment to use when processing the first web page request. The page generator module can generate the web page file for the segment dependent web page based on applying the targeting rule to the impersonated user segment and provide the web page file to the web server module.

According to another embodiment, a state machine can be provided having various states of operation including a first state non-impersonation mode and a second state impersonation mode. In the first state, the state machine can operate in a non-impersonation mode of operation and in the second state the state machine can operate in an impersonation mode of operation. The state machine may be operatively coupled to a repository storing web page definitions, impersonated user profiles and other information. The state machine can receive requests associated with a website visitor for segment dependent web pages. In the first state, the state machine can request visitor segments (a single visitor segment or multiple visitor segments) corresponding to the web site visitor from a segment provider. The state machine can further process requests associated with the website visitor to generate web page files for the segment dependent web pages based on applying a set of targeting rules to the visitor segments associated with the visitor. In the second state, the state machine can process the requests associated with the visitor using impersonated user segments (a single impersonated user segment or multiple impersonated user segments) specified by a user to generate the web page files by applying the set of targeting rules to the impersonated user segments.

### BRIEF DESCRIPTION OF THE DRAWINGS

A more complete understanding of the disclosure and the advantages thereof may be acquired by referring to the following description, taken in conjunction with the accompanying drawings in which like reference numbers indicate like features and wherein:

FIG. 1 is a diagrammatic representation of one embodiment of a network;

FIG. 2 is a diagrammatic representation of another embodiment of a network;

FIGS. 3A and 3B are simplified block diagrams illustrating embodiments of processing a web page request in different modes of operation;

FIG. 4 is a flow chart of one embodiment of defining targeting rules;

FIG. 5 is a flow chart of one embodiment of defining an impersonated user profile;

FIG. 6 is a flow chart of one embodiment of authenticating a user;

FIG. 7 is a flow chart of one embodiment of selecting an impersonated user profile;

FIG. 8 is a flow chart of one embodiment of updating the selection of an impersonated user profile;

FIG. 9A is a flow chart of one embodiment of responding to a request;

FIG. 9B is a flow chart of another embodiment of responding to a request;

FIG. 10A is a flow chart of yet another embodiment of responding to a request;

FIG. 10B is a flow chart of yet another embodiment of responding to a request;

FIG. 11 is a diagrammatic representation of one embodiment of a web development system;

FIG. 12 is a is a diagrammatic representation of one embodiment of a content object model;

FIG. 13 is a diagrammatic representation of one embodiment of a site structure;

FIG. 14 is a diagrammatic representation of one embodiment of providing a web page to a user;

FIG. 15 is a diagrammatic representation of one embodiment of a GUI for specifying targeting rules;

FIG. 16 is a diagrammatic representation of another embodiment of a GUI for specifying targeting rules;

FIG. 17 is a diagrammatic representation of one embodiment of a GUI that can be provided in a website development application to display targeting rules;

FIG. 18 is a diagrammatic representation of one embodiment of a GUI that can be provided to allow selection of an impersonation profile;

FIG. 19 is a diagrammatic representation illustrating a state of one embodiment of impersonation display;

FIG. 20 is a diagrammatic representation illustrating another state of one embodiment of impersonation display;

FIG. 21 is a diagrammatic representation illustrating yet another state of one embodiment of impersonation display; and

FIG. 22 is diagrammatic representation of one embodiment of a segment provider interface for segment providers in a pluggable framework.

The drawings accompanying and forming part of this specification are included to depict certain aspects of the disclosure. It should be noted that the features illustrated in the drawings are not necessarily drawn to scale.

### DETAILED DESCRIPTION

Systems and methods for website impersonation and various features and advantageous details thereof are explained more fully with reference to the exemplary, and therefore non-limiting, embodiments illustrated in the accompanying drawings and detailed in the following description. Descriptions of known programming techniques, computer software, hardware, operating platforms and protocols may be omitted so as not to unnecessarily obscure the disclosure in detail. It should be understood, however, that the detailed description and the specific examples, while indicating the preferred embodiments, are given by way of illustration only and not by way of limitation. Various substitutions, modifications, additions and/or rearrangements within the spirit and/or scope of the underlying inventive concept will become apparent to those skilled in the art from this disclosure.

According to embodiments described herein, a website system can operate in various modes of operation including in impersonation modes and non-impersonation modes. In a non-impersonation mode, the website system can process user requests for web pages in its normal fashion. In an impersonation mode, a user can force the website to use certain characteristics or segments when processing visitor requests, where the characteristics or segments do not necessarily correspond to the characteristics or segments associated with the visitor. In particular, embodiments can allow a user to specify impersonated user segments to use when processing a visitors request. The website system can generate instances of web pages based on the impersonated user segments rather than the segments that would be otherwise used for the visitor. This can allow the visitor (or other user) to test a website using different criteria and develop pages for segments of users in context of a production view.

According to one embodiment, the visitor can change the impersonated user segments in the context of the visitor's website session. Thus, the visitor may impersonate a variety of different visitors without logging in and out of the website under different accounts. This can facilitate testing of a large website with many segment dependencies.

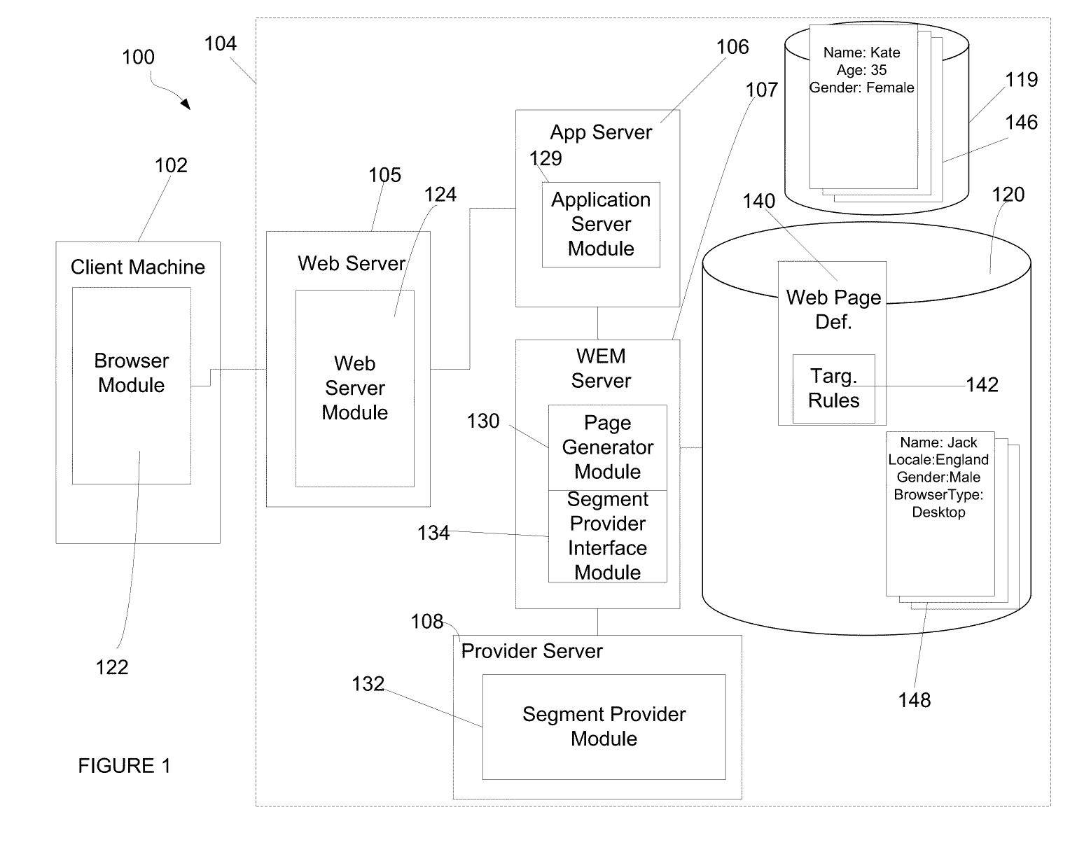

FIG. 1 is a diagrammatic representation of one embodiment of a network 100 comprising a client machine 102 coupled to a website system 104 having a web server 105, an application server 106, a second application server (referred to as a web experience management (WEM) server) 107 coupled to web server 105 through application server 106, a segment provider server 108, an application server repository 119 and a WEM repository 120. The client machine 102, web server 105, application server 106, WEM server 107 and segment provider server 108 can each include network interfaces, processors, memories and other computer readable mediums, I/O devices and other computer hardware known or developed in the art. Client machine 102, web server 105, application server 106, WEM server 107, application server repository 119, WEM repository 120 and segment provider server 108 may be coupled though one or more transmission channels including, LANs, WANs, the Internet or other transmission channels.

The client machine 102, web server 105, application server 106, WEM server 107 and segment provider server 108 can provide a number of modules including a web browser module 122, a web server module 124, an application server module 129, a page generator module 130, a segment provider module 132 and a segment provider interface module 134. The modules can be implemented as programmed logic (such as a processor coupled to a memory storing computer executable instructions executable by the processor), an ASIC or through other hardware. Multiple modules may be implemented using the same hardware or may be distributed. According to one embodiment, for example, browser module 122 may be implemented by a client computer running a web browser program or other program capable of making web requests and web server module 124 may be implemented by one or more web servers running a web server program. Furthermore, application server module 129, page generator module 130 and segment provider interface module 134 may be implemented by one or more application servers, WEM servers or other servers running an application configured to generate web pages and interface with a segment provider. Segment provider module 132 may be implemented by one or more segment provider servers running a segmentation program. In some cases, web server module 124, application server module 129, page generator module 130, segment provider module 132 and segment provider interface module 134 may be implemented on the same server. In other embodiments, the modules may be implemented by a set of cooperating servers controlled by one or more entities and in one or more domains.

In general, web browser module 122 issues HTTP requests (or other requests) for a web page to web server module 124, which processes the requests. Web server module 124 passes the requests or generates associated requests to application server module 129. Application server module 129 can further process the requests and invoke page generator module 130. Page generator module 130 generates web page file(s) for a requested web page (e.g., HTML, XML or other files) or fragment of a requested web page using assets in repository 120. Web server module 124 receives the web page file(s) from page generator module 130 or application server module 129 and returns the instance of the requested web page to web browser module 122. In some cases, web server module 124 may assemble files from multiple page generator modules 130 into an instance of a web page.

Repositories 119 and 120 can store a variety information used by web server module 124, application server module 129 and page generator module 130 to generate web pages, control access to web pages or otherwise manage distribution of web pages. If website visitors can register with the website, repository 119 may include a set of visitor profiles 146 containing information about website visitors used by application server module 129. A visitor profile 146 may include identification information, demographic information, visitor preferences or other information submitted or learned about a website visitor. Repository 120 may also store a set of impersonated user profiles 148 that a user can use to impersonate other users (e.g., for website testing). Impersonated user profiles 148 can be independent of visitor profiles.

Repository 120 can further store a set of one or more web page definitions used by page generator module 130 to generate web page files (a single web page definition 140 is illustrated). The web page definitions can specify the content, formatting or other aspects of a corresponding web page. To that end, a set of targeting rules 142 may be defined. Targeting rules 142 specify the dependencies between content, formatting or other aspects of the web page and characteristics of the requesting user or device or other characteristics.

In particular, the content, formatting or other aspects of the web page may depend on target segments that represent particular types of users, devices or conditions. Segments may correspond to demographics (e.g., male, female, age 30-40, etc.), locale (e.g., city, state, region, country, etc.), visitor type (new, returning, registered, etc.) interests (e.g., golfer, cyclist, mystery reader, etc.), type of device being using (desktop, mobile device, phone, tablet, etc.), browser being used or type of browser (e.g., desktop, mobile, etc.), times of day (e.g., morning, lunchtime, afternoon, evening, night, weekday, weekend, etc.), visit source (search engine, partner, analyst, blog, social network, etc.), display size (handheld, tablet, notebook, big screen, etc.), campaign (product launch, replacement campaign, upsell, etc.), language page is being viewed in, page format page is being viewed in (e.g., web, mobile, tablet, tv, etc.). Thus, targeting rules can be applied to create segment dependent web pages.

In some cases, segments can be considered as Boolean. That is, a visitor can be considered to either be in or not be in a segment (e.g., a user is either in or not in Age:35-40). Related segments may be grouped by a segment category. For example, a segment category may be “Age” with a member segment Age:35-40. In some cases, the segment category may be implied. For example, a segment of “Male” implies that segment type is “Gender.” In another example, if segment values are uniquely named, the segment value can imply a segment category. For example, a segment value of 30-45 may imply a segment type of Age. Segments can be used to group visitors that have different characteristics into a manageable number of groups. For example, visitors to a web site may be of any age. Rather than specifying rules for each age, visitors can be binned into age segments of “under 20,” “20-29,” “30-45,” etc. and rules applied based on the segments.

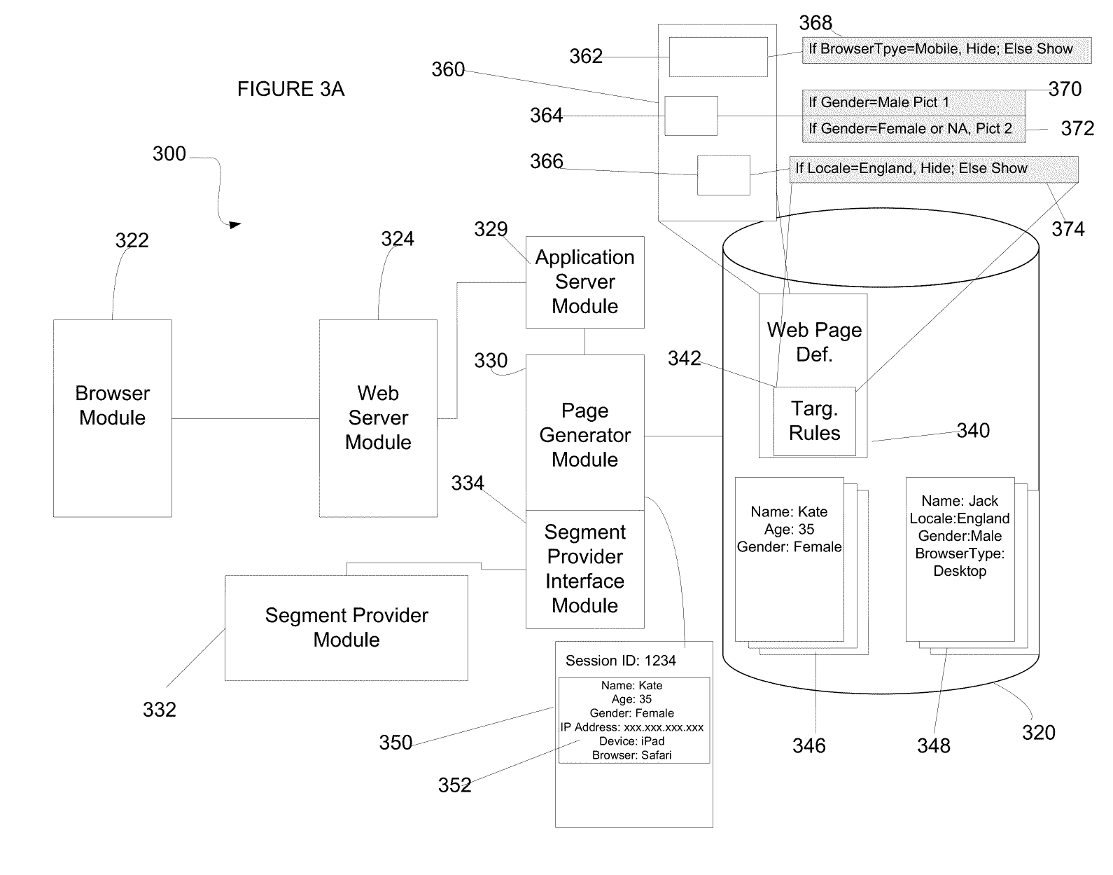

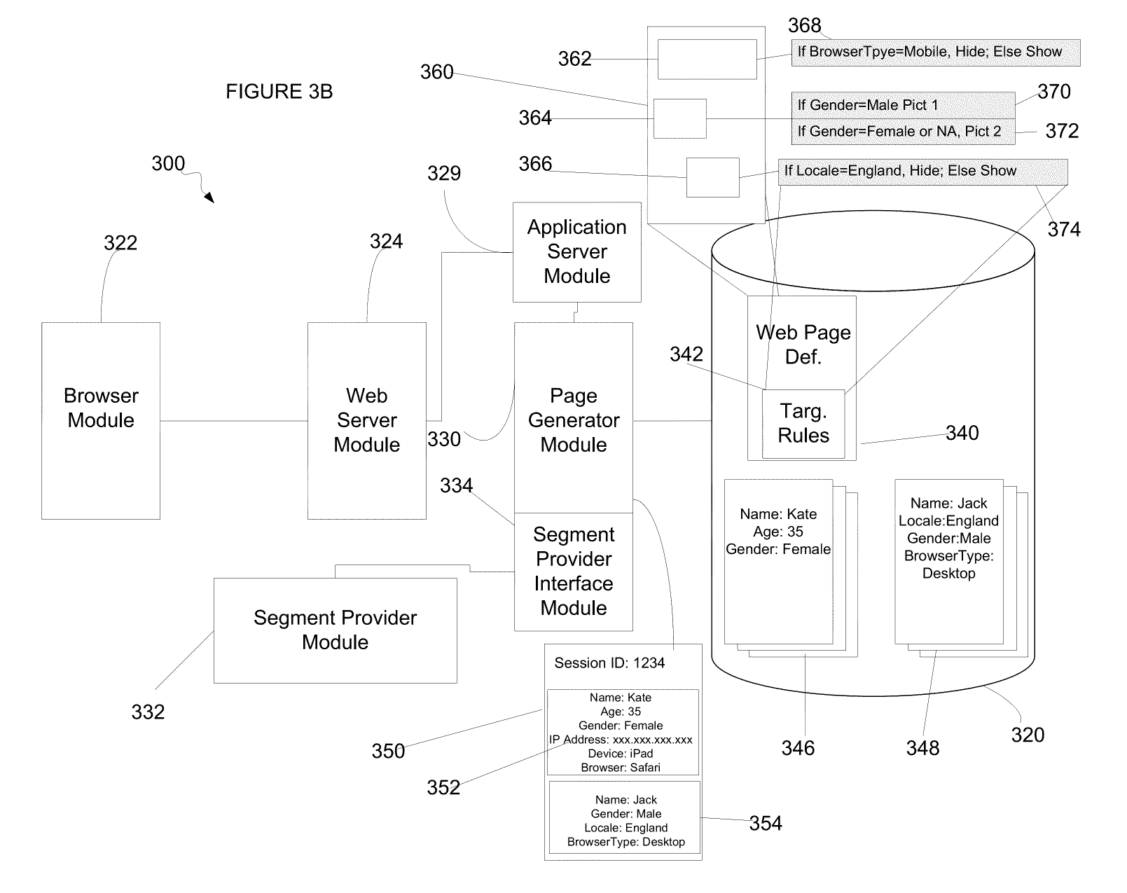

As page generator module 130 processes the appropriate web page definition for a request, page generator module 130 can determine the segment dependencies in the web page definition. Page generator module 130 can further determine the segments associated with the web page request and use the segments associated with the request when generating web page files according to the targeting rules. Page generator module 130 can operate in a number of modes of operation for processing requests including a non-impersonation mode and an impersonation mode. Examples of processing requests in these modes of operation are discussed below in conjunction with FIGS. 3A and 3B.

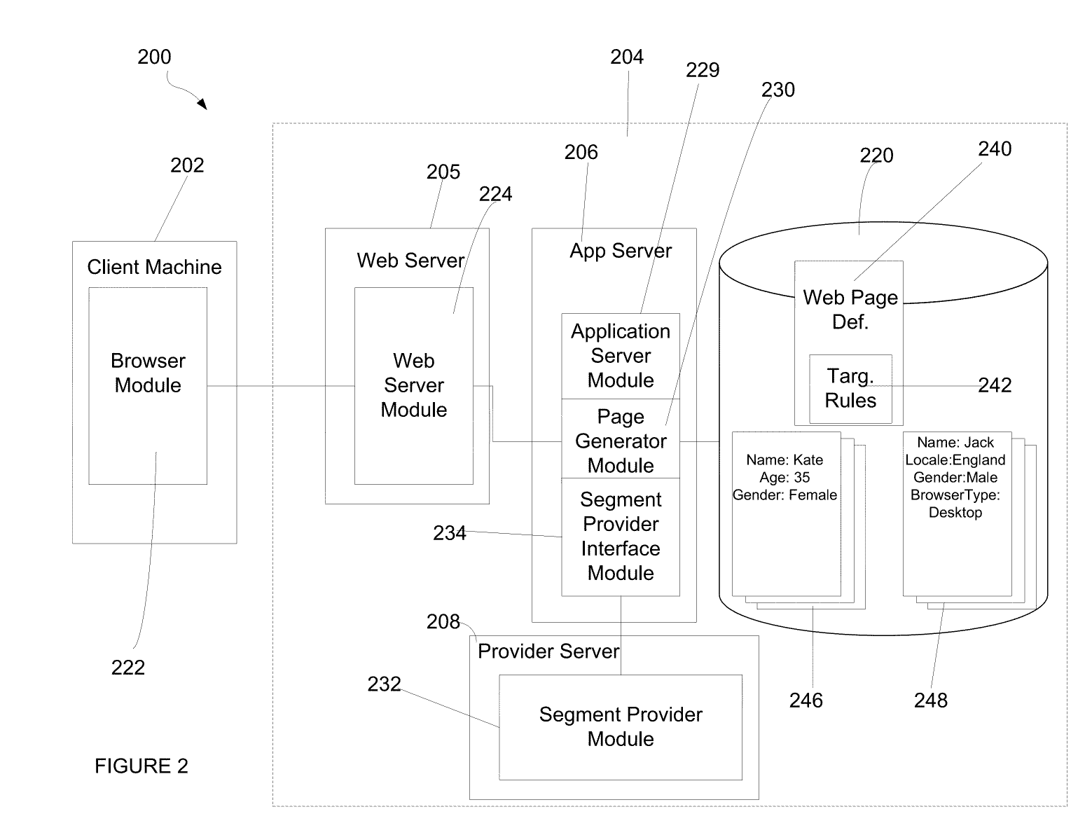

FIG. 2 provides a diagrammatic representation of another embodiment of a network 200 comprising a client machine 202 coupled to a website system 204 having a web server 205, an application server 206, a segment provider server 208 and a repository 220. The client machine 202, web server 205, application server 206 and segment provider server 208 can each include network interfaces, processors, memories and other computer readable mediums, I/O devices and other computer hardware known or developed in the art. Client machine 202, web server 205, application server 206, repository 220 and segment provider server 208 may be coupled though one or more transmission channels including, LANs, WANs, the Internet or other transmission channels.

The client machine 202, web server 205, application server 206 and segment provider server 208 can provide a number of modules including a web browser module 222, a web server module 224, an application server module 229, a page generator module 230, a segment provider module 232 and a segment provider interface module 234. The modules can be implemented as programmed logic (such as a processor coupled to a memory storing computer executable instructions executable by the processor), an ASIC or through other hardware. Multiple modules may be implemented using the same hardware or may be distributed. According to one embodiment, for example, browser module 222 may be implemented by a client computer running a web browser program or other program capable of making web requests and web server module 224 may be implemented by one or more web servers running a web server program. Furthermore, application server module 229, page generator module 230 and segment provider interface module 234 may be implemented by one or more application servers or other servers running an application configured to generate web pages and interface with a segment provider. Segment provider module 232 may be implemented by one or more segment provider servers running a segmentation program. In some cases, web server module 224, application server module 229, page generator module 230, segment provider module 232 and segment provider interface module 234 may be implemented on the same server. In other embodiments, the modules may be implemented by a set of cooperating servers controlled by one or more entities and in one or more domains.

In general, web browser module 222 issues HTTP requests (or other requests) for a web page to web server module 224, which processes the requests. Web server module 224 passes the requests or generates associated requests to application server module 229. Application server module 229 can further process the requests and invoke page generator module 230. Page generator module 230 generates web page file(s) for a requested web page (e.g., HTML, XML or other files) or fragment of a requested web page using assets in repository 220. Web server module 224 receives the web page file(s) from page generator module 230 or application server module 229 and returns the instance of the requested web page to web browser module 222. In some cases, web server module 224 may assemble files from multiple page generator modules 230 into an instance of a web page.

Repository 220 can store a variety of information used by web server module 224, application server module 229 and page generator module 230 to generate web pages, control access to web pages or otherwise manage distribution of web pages. If website visitors can register with the website, repository 220 may include a set of visitor profiles 246 containing information about website visitors used by application server module 229. A visitor profile 246 may include identification information, demographic information, visitor preferences or other information submitted or learned about a website visitor.

Repository 220 may also store a set of impersonated user profiles 248 that a user can use to impersonate other users (e.g., for website testing). Impersonated user profiles 248 can be independent of visitor profiles. Repository 220 can further store a set of one or more web page definitions used by page generator module 230 to generate web page files (a single web page definition 240 is illustrated). The web page definitions can specify the content, formatting or other aspects of a corresponding web page. To that end, a set of targeting rules 242 may be defined. Targeting rules 242 specify the dependencies between content, formatting or other aspects of the web page and characteristics of the requesting user or device or other characteristics. In particular, the content, formatting or other aspects of the web page may depend on target segments that represent particular types of users, devices or conditions.

As page generator module 230 processes the appropriate web page definition for a request, page generator module 230 can determine the segment dependencies in the web page definition. Page generator module 230 can further determine the segments associated with the web page request and use the segments associated with the request when generating web page files according to the targeting rules. Page generator module 230 can operate in a number of modes of operation for processing requests including a non-impersonation mode and an impersonation mode.

FIGS. 3A and 3B provide diagrammatic representations of a system 300 processing requests in different modes of operation. For the sake of explanation, system 300 is shown having a web browser module 322, a web server module 324 and application server module 329, a page generator module 330, a segment provider module 332, and a segment provider interface module 334. Furthermore, the system may comprise a repository 320 storing web page definitions 340, visitor profiles 346 and, impersonated user profiles 348. While shown as a single repository for the sake of simplicity, multiple repositories may be used.

Referring to FIG. 3A, FIG. 3A is a simplified block diagram illustrating one embodiment of processing a web page request in a non-impersonation mode. When page generator module 330 receives a web page request, whether forwarded from a visitor or generated by application server module 329, the web page requests can be associated with a website visitor. According to one embodiment, for example, when browser module 322 connects to website server module 324 a set of session information 350 can be established for a visitor as would be understood by those of ordinary skill in the art. Requests from the visitor during the session are associated with the session.

The session information can include a set of visitor session data 352 used to track a visitor and the state of interactions with the visitor. In this context, the visitor is the web server module's 324, application server module's 329 and/or page generator module's 330 understanding of who is making a web page request or related set of web page requests. The visitor, in some cases, may be an administrator or web site developer accessing the web pages to test, author, etc. web pages. In some cases, the visitor may simply be a temporary visitor established for the sake of tracking the session; while in other cases, the visitor may be associated with a defined visitor profile 346. The session information 350 may be updated based on visitor interactions, visitor profile information or other information. For example, if a visitor logs into a website, some or all of the visitor profile information for the visitor may be added to visitor session data 352. Session information 350 may be maintained as a client-side session, a server-side session or otherwise and may include storing session information in cookies. According to one embodiment, session information 350 expires and may be deleted at the end of a website session.

Session information 350 may include a set of visitor session data 352 that includes data associated with the visitor and visitor requests. This can include, for example, segments associated with the visitor, characteristics derived from the visitor's request(s), characteristics derived from the user's activities on the website, characterizes derived from the visitor's interactions with other websites or systems, if the information is shared, and other information. For example, visitor session data 352 may include demographic data loaded from a visitor profile 346 or otherwise determined for the visitor, a browser type and computer type determined from the visitor's requests in a session, user preferences or other information. This information can be used by page generator module 330 to target a web page to the visitor. As page generator module 330 processes the appropriate web page definition, page generator module 330 can determine the target segments for the web page; that is, page generator module 330 can determine the segments referenced in the targeting rules in the web page definition. To increase processing speed of the next request for the same page, page generator module may cache the target segments.

Page generator module 330 can further determine if visitor segments match the target segments; that is, page generator module 330 can determine if the visitor is associated with any of the segments specified as a target segment. To this end, page generator module 330 can determine if session information 350 defines any visitor segments matching the target segments. In addition, page generator module 330 may send a segment request to the segment provider module 332 to request visitor segments. For convenience and to increase future request processing speed, page generator module 330 may cache the returned visitor segments in visitor session data 352.

According to one embodiment, page generator module 330 can send some or all of visitor session data 352, other parameters from a web page request or other information to the segment provider module 332 in the segment request to request segments corresponding to the website visitor, one example of which is as follows:
List<String>getSegments(Request)//get segments defined by this provider to which the given request (visitor) belongs

Segment provider module 332 returns the visitor segments to page generator module 330. Thus, page generator module 330 can determine visitor segments in runtime by querying the segment provider.

According to another embodiment, page generator module 330 sends the target segments and some or all of session information 350, parameters from a web page request or other information to the segment provider module 332. Segment provider module 332 can then respond with an indication of the target segments corresponding to the visitor.

Based on the match between the target segments and the visitor segments, page generator module 330 can appropriately generate the web page file(s) for the requested web page. If there is no match for a particular target segment, page generator module 330 can generate the web page file(s) according to defaults.

To provide an example, assume web page definition 340 defines a product web page 360 (at \\site1.com\product_A\) having first component 362, second component 364 and third component 366. Furthermore, web page definition 340 includes the following example targeting rules 342:
a. targeting rule 368: if BrowserType:Mobile, first component 362 will be hidden, else show component 362;
b. targeting rule 370: if Male, second component 364 will include a picture of a man using a product;
c. targeting rule 372: if Female or unspecified, second component 364 will include a picture of a woman using the product:
d. targeting rule 374: if Locale:England, third component 366 will be hidden, else component 366 will be shown.

Under these targeting rules, there are eight possible versions of web page 360 that can be generated for a visitor.

Furthermore, for the sake of example in FIG. 3A, visitor session data 352 for visitor Kate includes the following information:
e. Session ID: 1234
f. Name: Kate
g. Age: 35
h. IP Address: xxx.xxx.xxx.xxx
i. Gender: Female
j. Device: iPad
k. Browser: Safari

In operation, when page generator module 330 receives a request for the \\site1.com\product_A\, page generator module 330 traverses web page definition 340 and determines that the target segments are Browser Type:Mobile, Male, Female and Locale:England. Page generator module 330 can then determine which target segments the visitor session data 352 matches.

Page generator module 330 accesses session information 350 and determines if any visitor segments already stored in visitor session data 352 match the target segments. In this example, the visitor segments Female matches the target segment Female. For the remaining target segments, page generator module 330 may send a segment request to segment provider module 332 for the other visitor segments. The request may only include the information relevant for determining the target segments or may include information for determining all (or some subset) of segments corresponding to the visitor. For example, page generator module 330 can send a request specifying: IP Address:xxx.xxx.xxx.xxx, Device:iPad, Browser:Safari, Age:35 to the segment provider and receive the matching segments: Locale:US, BrowserType:Mobile, Age:30-45. While the “Age” segment is not at issue in the particular example, it may be helpful to request all the visitor segments at one time. Page generator module may store one or more of the received visitor sessions in visitor session data 352.

Page generator module 330 can then match the visitor segments to the appropriate target segments and generate the web page files accordingly. In the example of visitor “Kate”, page generator module 330 will generate file(s) for an instance of product web page 360 with component 362 hidden (applying targeting rule 368 to BrowserType:Mobile), a picture of a woman using the product (applying targeting rules 370 and 372 to Female) and component 366 displayed (applying targeting rule 374 to Locale:US).

In another embodiment, page generator module 330 may send target segments and session information to segment provider module 332 and receive a response indicating matches. For example, page generator module 330 may send: Session Information: Device:iPad, Browser:Safari, IP Address xxx.xxx.xxx.xxx and target segments: BrowserType:Mobile, Male, Female, Locale:England and receive back and indication of BrowserType:Mobile=T, Male=F, Female=T, Locale:England=F. In this example, segment provider module 332 returns the matches and page generator module 330 generates the page files accordingly.

As noted above, page generator module 330 can provide web page files for any one eight versions of page 360, depending on the visitor segments. However, visitor Kate only sees one version based on her segments. If a website developer desires to test each version of the a website seen by different website visitors from different segments (including Kate), the website developer would have to follow a process similar to the following:
i) create a Male visitor profile and a Female visitor profile;
ii) in a first session, log into the website with the Male account using a mobile device having an IP address associated with England and request the page;
iii) in a second session, log into the website with the Female account using a mobile device from an IP address associated with England and request the page;
iv) in a third session, log into the website with the Male account using a non-mobile device having an IP address associated with England and request the page;
v) in a fourth session, log into the website with the Female account using a non-mobile device having an IP address associated with England and request the page;
vi) in a fifth session, log into the website with the Male account using a mobile device having an IP address not associated with England and request the page;
vii) in a sixth session, log into the website with the Female account using a mobile device having an IP address not associated with England and request the page;
viii) in a seventh session, log into the website with the Male account using a non-mobile device having an IP address not associated with England and request the page;
ix) in an eight session, log into the website with the Female account using a non-mobile device having an IP address not associated with England and request the page.

As can be seen, it is cumbersome to test a single web page, even when the user segments can be derived from a small number of parameters (e.g., IP address, device and browser, etc.). The website developer will have to log into and off the website multiple times using different accounts, changing locations and changing browser/device combinations. This task becomes even more difficult if any of the user segments must be determined from browsing history, product purchases or other more complex interactions.

To reduce the burden of testing a website, page generator module 330 may operate in an “impersonation mode.” In the impersonation mode, a website developer may force page generator module 330 to use particular impersonated user segments or characteristics. This can allow the website developer to test web pages without having to develop the correct visitor profile, use the correct browser or device, or log in from the correct locale, etc. Moreover, page generator module can allow the website visitor to apply multiple impersonated user profiles within a context of a single session. Thus, the user can change the impersonated user segments within the context of a single session. Page generator module 330 can then generate web page files for requests associated with web site visitors using the updated impersonated user segments. Consequently, the visitor does not have repeatedly log off and log on to the website under different accounts and with different devices to experience the website for different visitor segments.

FIG. 3B is a simplified block diagram illustrating embodiment of processing a request in a website system operating in an impersonation mode. For the sake of simplicity, FIG. 3B will use the same example web page definition 340 and targeting rules 342 discussed in conjunction with FIG. 3A.

Page generator module 330 can operate in an impersonation mode in which page generator module 330 uses impersonated user segments when generating web page file(s). Page generator module 330 can be placed in impersonation mode by web browser module 322, a management console or through other mechanism. Furthermore, web browser module 322, the management console or the like can send an indication of the impersonated user segments that page generator module 330 should use when processing one or more web page requests.

Web browser module 322 may use a web page request or other request to set the impersonation mode. For example, web browser module 322 can include a parameter in a URL request for page 360 or other web page indicating that page generator module 330 should process the request in the impersonation mode. In some embodiments, page generator module 330 sets a flag in session information 350 indicating that it is in impersonation mode or otherwise stores an indication that page generator module 330 is in impersonation mode. Impersonation mode can persist until the web page request is serviced, web browser module 322 indicates that impersonation mode should terminate, the session ends or at the occurrence of another event. Page generator module 330 may operate in an impersonation mode on a session by session basis such that page generator module 330 may service requests from some visitors in impersonation mode and service requests from other visitors in an non-impersonation mode.

When page generator module 330 is in an impersonation mode of operation, page generator module 330 can determine that a request should be serviced using impersonated user segments. Page generator module 330 can determine the impersonated user segments to use and add the impersonated user segments to session information 350 as impersonated user data 354. The impersonated user segments may differ from the visitor segments of the visitor making the request.

For impersonation mode, web browser module 322 can provide a profile of impersonated user segments for page generator module 330 to use when processing targeting rules 342. According to one embodiment, the impersonated user segments can be specified in the URL request. One example embodiment of such a request is:
\\site1.com\Product_A\?imperson=yes&Gender=Female&Browser=Mobile&Locale=US.

In another embodiment, repository 320 may store a set of impersonated user profiles 348 containing impersonated user segments. Accordingly, web browser module 322 can specify an impersonated user profile 348 to use. According to one embodiment, a URL request may specify a requested web page, the impersonation mode and an impersonation profile name. An example embodiment of such a request specifying a profile for “Jane” is:
\\site1.com\Product_A?vgnExtSegProfileld=guid
   where guid is a globally unique id for the profile “Jane.” Page generator module 330 can then use the profile for Jane when servicing requests from the visitor in impersonation mode.

As page generator module 330 processes the appropriate web page definition, page generator module 330 can determine the target segments for the web page; that is, page generator module 330 can determine the segment categories and/or segments referenced in the targeting rules in the web page definition. To increase processing speed of the next request for the same page, page generator module may cache the target segments/segment categories.

Page generator module 330 can further determine if any of the impersonated user segments in session information 350 match the target segments. If there are target segment categories for which impersonated user data 354 does not specify a segment, page generator module 330 can generate the page according to a default for the targeting rule. Page generator module 330 can then generate the appropriate web page files for the impersonated user segments or combination of impersonated user segments and visitor segments.

To provide an example, an impersonated user profile for “Jack” can be established as follows.
l. Name: Jack
m. Locale: England
n. Gender: Male
o. Browser_Type: Desktop
In addition, an impersonated user profile for “Jill” can be established as follows:
p. Name: Jill
q. Locale: France

Furthermore, for the sake of example, the website developer from the example of FIG. 3A can place page generator module 330 in an impersonation mode and specify the impersonated user profile “Jack”.

In operation, page generator module 330 can access the impersonated user profile for Jack and place Locale:England, Male, Browser_Type:Desktop in the impersonated user data 354 for the session information 350 associated with Kate. When page generator module 330 receives a request for the \\site1.com\product_A\ from Kate, page generator module 330 traverses web page definition 340 and determines that the target segments are BrowserType:Mobile, Male, Female and Locale:England. Page generator module 330 can then determine which target segments the impersonated user data 354 matches.

To this end, page generator module 330 can access session information 350 and determine if any impersonated user segments already stored in impersonated user data 354 match the target segments. In this example, impersonated user segments match the target segments Male and Locale:England. Furthermore, page generator module 330 can determine that the impersonated user data 354 includes a segment for BrowserType that does not match the targeting rule for BrowserType:Mobile. Page generator module 330 therefore has all the segment information it needs to generate the files for an instance of the web page according to the targeting rules. In this example, page generator module 330 will generate web page files for an instance of web page 360 having component 362 not hidden (per targeting rule 368 applied to BrowerType:Desktop), component 364 having a picture of a man using the product (per targeting rule 370 and targeting rule 372 applied to Male) and component 366 hidden (per targeting rule 374 applied to Locale:England). Thus, the visitor Kate, a woman using a mobile browser from the United States, can see how the web page would be generated for a man using a desktop browser in England.

According to one embodiment, the website developer can now indicate that page generator module 330 should switch to using the impersonated profile for Jill. Page generator module 330 can access the impersonated user profile for Jill and update impersonated user data 354 in the session information 350 to include: Locale:France, replacing the impersonated user information for Jack with the impersonated user information for Jill. Now when page generator module 330 processes a request associated with user Kate for the web page \\site1.com\product_A\, page generator module 330 can determine that the impersonated user data 354 specifies a segment of Local:US, which does not meet targeting rule 374. Because the impersonated user data 354 does not specify values for the segment categories BrowserType or Gender, page generator module 330 can either apply default rules.

Using the impersonated user segments for Jill, page generator module 330 can generate the appropriate file(s) for an instance of web page 360. In this example, page generator module 330 will generate web page files for an instance of web page 360 with component 362 not hidden (according to targeting rule 368 applied to the visitor segment unspecified associated with Jill), a picture of a woman using the product (according to targeting rules 370 and 372 applied to neither Male nor Female being associated with Jill) and component 366 displayed (according to targeting rule 374 applied to the impersonated user segment Locale:France specified for Jill).

In another embodiment, page generator module 330 can determine the BrowserType and

Gender values to use based on the visitor session data 352 for Kate as discussed above in conjunction with FIG. 3A. Using a combination of impersonated user segments for Jill and visitor segments for Kate, page generator module 330 can generate the appropriate web page file(s) for the instance of web page 360. In this example, page generator module 330 will generate web page files for an instance of web page 360 with component 362 hidden (according to targeting rule 368 applied to the visitor segment BroswerType:Mobile associated with Kate), a picture of a woman using the product (according to targeting rule 372 applied to the visitor segment Female associated with Kate) and component 366 displayed (according to targeting rule 374 applied to the impersonated user segment Locale:France specified for Jill).

It can be noted that, in one embodiment, the website developer may switch between different impersonated user profiles within the context of the same visitor session. By setting up eight impersonated user profiles, the website developer can test all eight versions of web page 360 without having to log in and out using different visitor profiles, change locations to test locale dependencies or change device/browser combinations to test BrowserType dependencies. For a large website with many segment dependencies, this can greatly decrease the time and complexity of testing the website.

It can also be noted that in some embodiments, the impersonated user data may include specified parameters that are used by the segment provider to determine the segments. In such an embodiment, the page generator module 330 can send the impersonated user parameters to the segment provider and receive the corresponding impersonated user segments in return. For example, an impersonated user profile for “Bill” may include the following data:
a. Name: Bill
b. Locale: England
c. Male
d. Browser: Safari
e. Device: Mac

When the visitor selects to use the profile “Bill”, the website system can send the parameters for Bill to segment provider module 332 and receive the impersonated user segments in return. For example, the website system can send Broswer:Safari and Device:Mac to segment provider module 332 and receive BrowserType:Desktop in return. Thus, in some embodiments, the website system can still provide information to the segment provider when operating in impersonation mode to retrieve the impersonated user segments rather than requiring that the user explicitly define the impersonated user segments.

According to one embodiment, a server or other computer or hardware system with control logic may comprise a state machine having various states of operation including a first state non-impersonation mode and a second state impersonation mode. In the first state, the state machine can operate in a non-impersonation mode of operation and in the second state the state machine can operate in an impersonation mode of operation. The state machine may be operatively coupled to a repository storing web page definitions, impersonated user profiles and other information. The state machine can receive requests associated with a website visitor for segment dependent web pages. In the first state, the state machine can request visitor segments (a single visitor segment or multiple visitor segments) corresponding to the web site visitor from a segment provider. The state machine can further process requests associated with the website visitor to generate web page files for the segment dependent web pages based on applying a set of targeting rules to the visitor segments associated with the visitor. In the second state, the state machine can process the requests associated with the visitor using impersonated user segments (a single impersonated user segment or multiple impersonated user segments) specified by the visitor to generate the web page files by applying the set of targeting rules to the impersonated user segments.

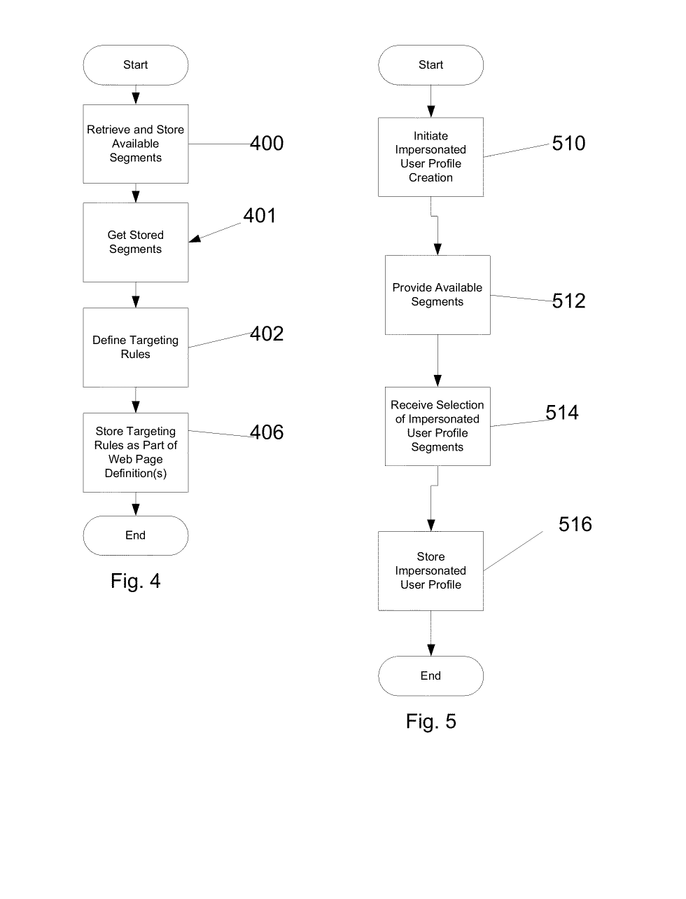

FIG. 4 is a flow chart illustrating one embodiment of one embodiment of establishing segment dependencies for a website. At step 400, available segments can be imported from segment providers. The segments are retrieved from one or more segment providers and stored. One example of a request can be as follows:
List<String>getAllSegments( )//get all segments defined by this provider

The segment provider can return all available segments for use in the website. This may include returning a list of available segment categories and values.

To define a targeting rule, a user can access the stored segments (step 401). At step 402, a user can select content, formatting or another aspect of a web page and specify targeting rules based on the available segments. The targeting rules can be stored as part of the web page definition (step 406). The steps of FIG. 4 can be repeated as needed or desired, additional steps added, the steps performed in other orders and some steps omitted.

FIG. 5 is a flow chart of one embodiment of a method for creating an impersonated user profile. Impersonated user profile creation can be initiated by a web browser, management application or other application (step 510). The user can be provided with a list of available segments for use in the website (step 512) and the website system can receive the selection of impersonated user profile segments (step 514). An impersonated user profile with the selected segments can be stored (step 516). The steps of FIG. 5 can be repeated as needed or desired, additional steps added, the steps performed in other orders and some steps omitted.

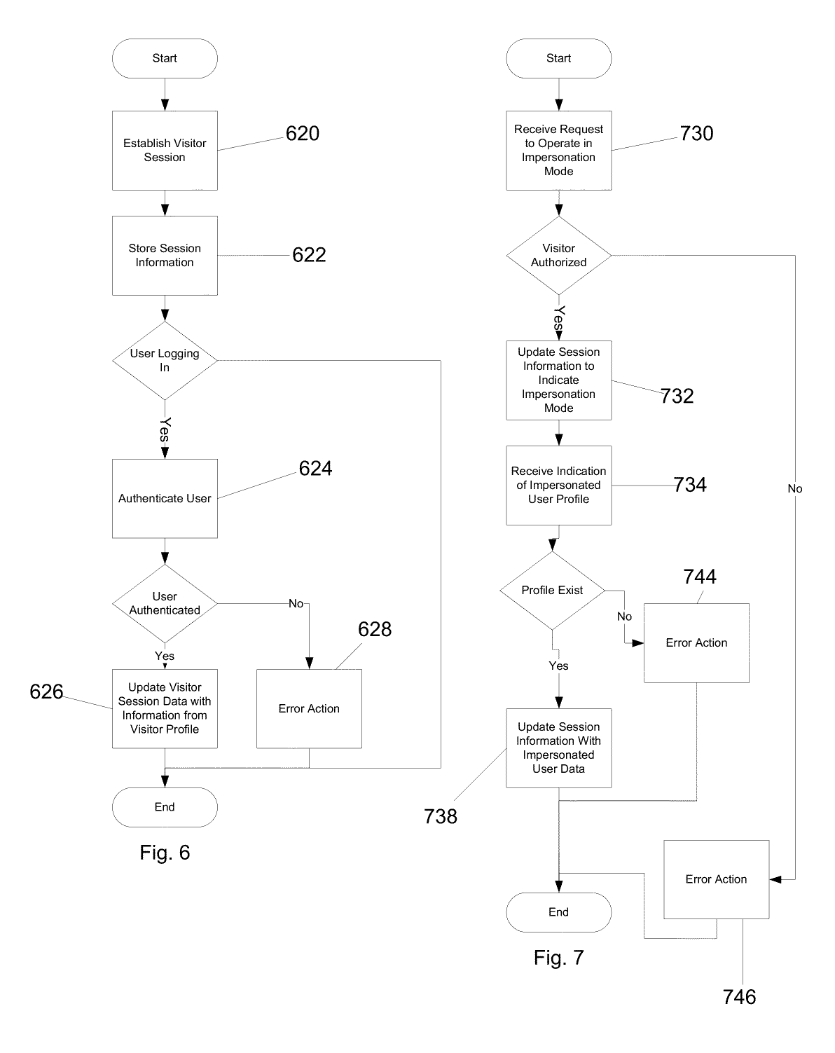

FIG. 6 is a flow chart of one embodiment of a method for maintaining information about a website visitor. When a visitor connects to a website, the website system can establish a visitor session (step 620) and store session information (step 622). The session information may be maintained at the website system and/or the browser and can be exchanged through the use of cookies or other mechanisms.

If the user logs on to the website, the website system can authenticate the user (step 624) and if the user is authenticated update the session information for the user (step 626). This can include, for example, reading information from a visitor profile and adding the information to the session information. Thus, at least a portion of the visitor session data can be loaded from a visitor profile. If the user is not authenticated, an error can be generated or other action taken (step 628). Session information may be updated as the user interacts with the website. The steps of FIG. 6 can be repeated as needed or desired, additional steps added, the steps performed in other orders and some steps omitted.

FIG. 7 is a flow chart illustrating one embodiment of a method for establishing an impersonation mode at a website system. At step 730, the website system can receive a request from a visitor to operate in an impersonation mode. If the visitor is authorized to select the impersonation mode, the website system can update session information associated with the visitor to indicate that the website system should operate in impersonation mode for requests from that visitor (step 732).

At step 734, the website system can receive an indication of an impersonation profile to use. By way of example, but not limitation, the website system can receive a name of an impersonated user profile. If the requested profile exists, the website system can access the profile and update the session information with impersonated user data (step 738). Thus, at least a portion of the impersonated user data can be loaded from a selected impersonated user profile. The impersonated user data can be added to the session data while maintaining the requesting visitor session data in the session information. Accordingly, the visitor session data and impersonated user data can be associated with the same session. If the profile does not exist, the website system can take a specified error action, such as exiting impersonation mode, requesting that the visitor create the profile or taking another action (step 744).

Turning briefly to step 746, if a visitor requesting impersonation mode is not authorized to do so, the website system can take a specified error action, such as sending an error page or taking another action. The steps of FIG. 7 can be repeated as needed or desired, additional steps added, the steps performed in other orders and some steps omitted.

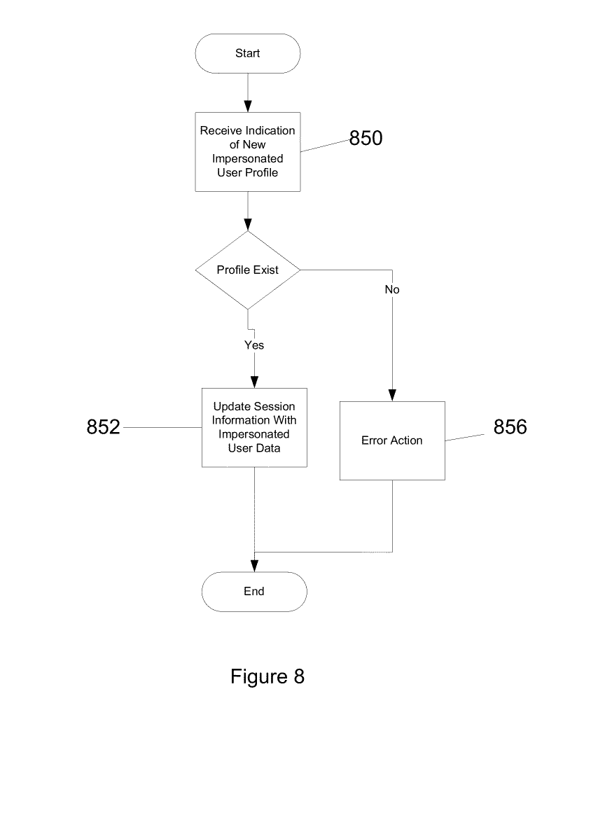

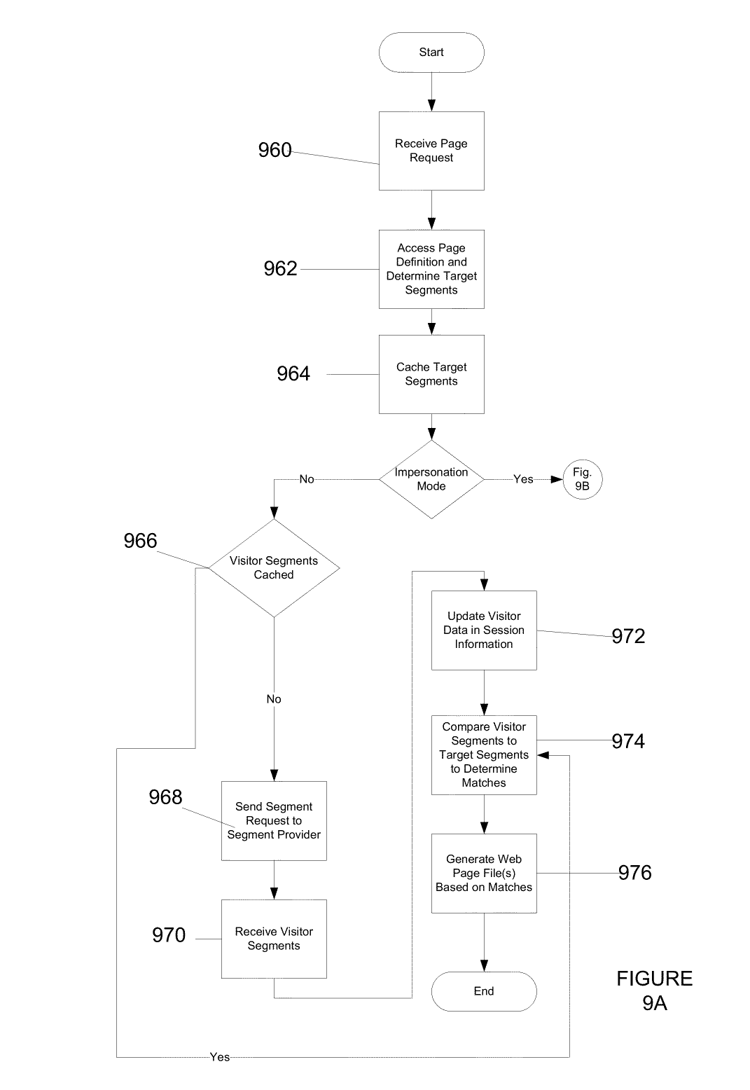

FIG. 8 is a flow chart of one embodiment of a method for changing an impersonated user profile in an impersonation mode. At step 850, an indication of a new impersonated user profile can be received. For example, a website system may receive a new profile name. If the profile exists, the website system can update the session information with the impersonated user data for the new profile (step 852). If the profile does not exist, the website system can take a specified error action, such as exiting impersonation mode, requesting that the visitor create the profile or taking another action (step 856). The steps of FIG. 8 can be repeated as needed or desired, additional steps added, the steps performed in other orders and some steps omitted.

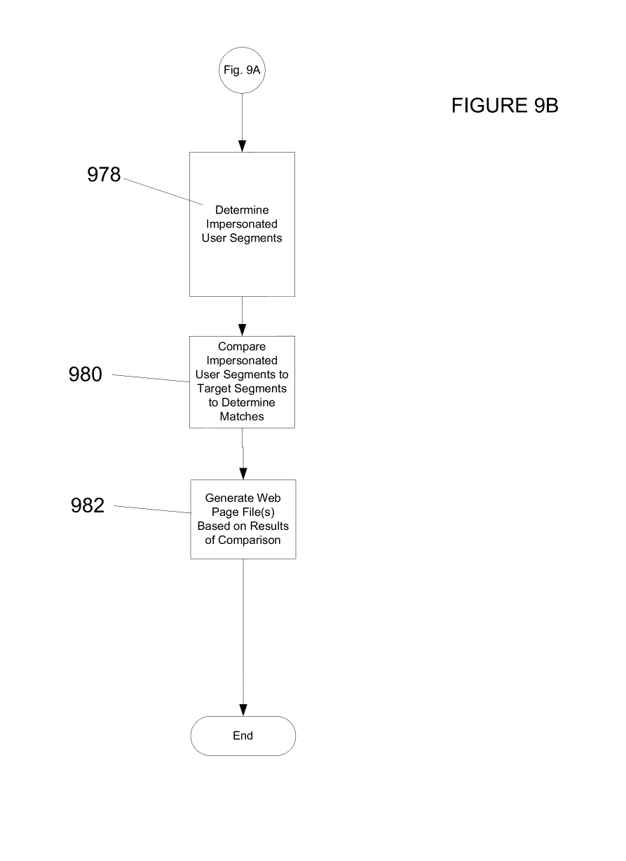

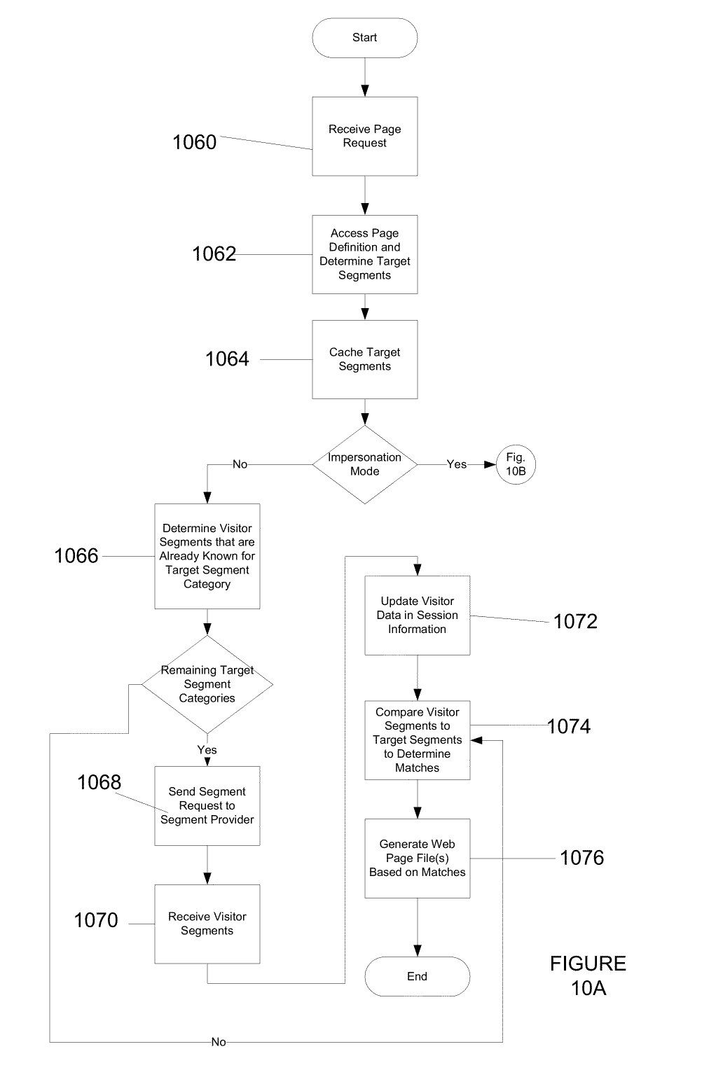

FIGS. 9A and 9B are flow charts illustrating one embodiment of a method for processing web page requests from a visitor. According to one embodiment, the methods of FIGS. 9A and 9B can be implemented at an application server, development server or other server system. Referring to FIG. 9A, at step 960, a page generator module can receive a web page request for a segment dependent web page, where the web page request is associated with a website visitor. The page generator module can access a page definition for the requested webpage, parse the targeting rules and determine the target segments (step 962) associated with the segment dependent web page. The target segments for the web page can be cached (step 964). The page generation module can determine a mode of operation from processing the web page request. If the page generation module in is in an impersonation mode for the requesting visitor, control can pass to FIG. 9B. Otherwise, control can pass to step 966.

At step 966, the website system can determine already known visitor segments for target segment categories. In one embodiment, website system can determine the visitor segments are already cached in the session data or elsewhere. If the visitor segments are not cached, the page generator module can send a request to a segment provider (step 968) to request visitor segments corresponding to the website visitor and receive the visitor segments in response (step 970). The website system can update the visitor session data in the session information with the received visitor segments (step 972).

The page generator module can process the request associated with the website visitor for the segment dependent web page using the visitor segments associated with the website visitor provided by the segment provider or previously cached to generate web page files for the segment dependent web pages. In general, page generator module can generate web page files based on applying targeting rules associated with the requested segment dependent web page to the visitor segments.

In one embodiment, the page generator module can compare the visitor segments associated with the website visitor to the target segments to determine matches (step 974). At step 976, the page generator module can generate the web page files according to the targeting rules and based on the matches between visitor segments and target segments. According to one embodiment, if the visitor segments do not contain a match for a target segment specified in a targeting rule for an aspect of a web page, that aspect of the web page can be generated based on a default.

Referring to FIG. 9B, if the page generator module system is operating in an impersonation mode, the page generator module can process the requests associated with the website visitor for the segment dependent web page using impersonated user segments specified by a user to generate the web page files. According to one embodiment, the page generator module can apply the set of targeting rules to the impersonated user segments to generate the web page files.

In the impersonation mode, the page generator module can determine the impersonated user segments (e.g., from the session data or elsewhere) (step 978) and compare the impersonated user segments to the target segments to determine matches (step 980). At step 982, the page generator module can generate the web page files according to the targeting rules and based on the matches between impersonated user segments and target segments. According to one embodiment, if the impersonated user segments do not include a match for a target segment specified in a targeting rule for an aspect of a web page, that aspect of the web page can be generated based on a default.

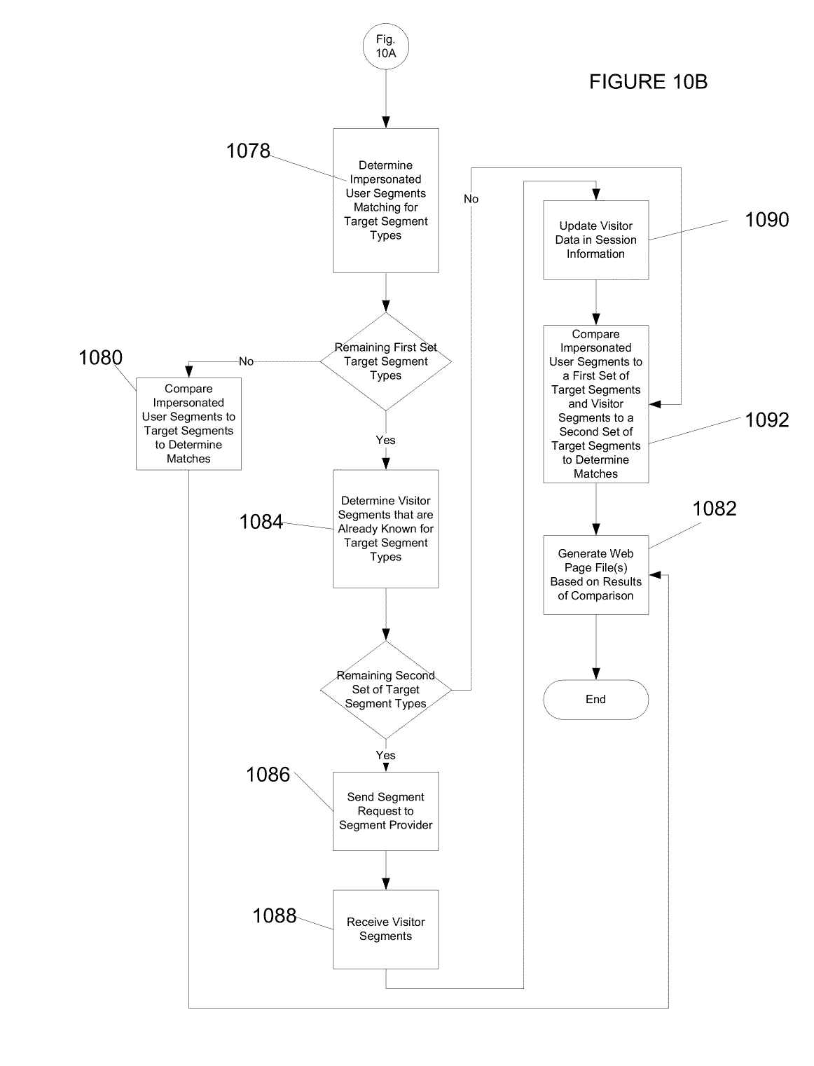

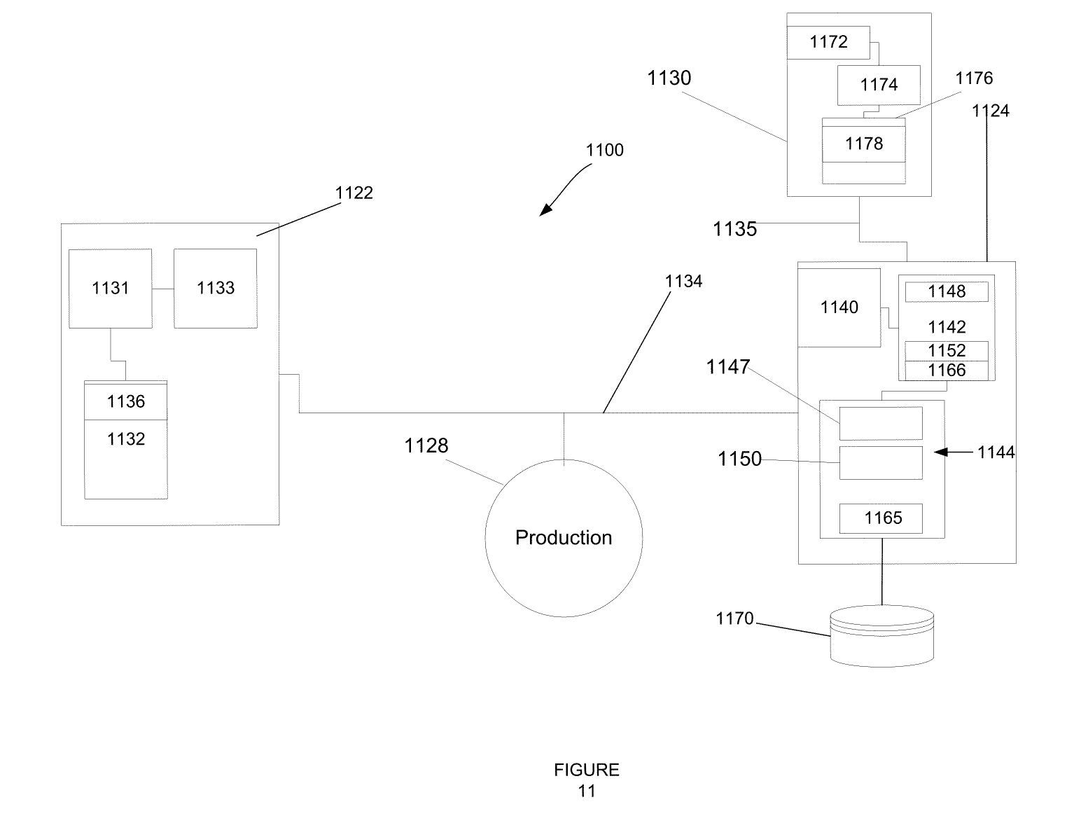

FIGS. 10A and 10B are flow charts illustrating another embodiment of a method for processing web page requests from a visitor. According to one embodiment, the methods of FIGS. 10A and 10B can be implemented at an application server or other server or system. Referring to FIG. 10A, at step 1060, a page generator module can receive a web page request for a segment dependent web page, where the web page request is associated with a website visitor. The page generator module can access a page definition for the requested webpage, parse the targeting rules and determine the target segments (step 1062) associated with the segment dependent web page. The target segments for the web page can be cached (step 1064). The page generation module can determine a mode of operation from processing the web page request. If the page generation module in is in an impersonation mode for the requesting visitor, control can pass to FIG. 10B. Otherwise, control can pass to step 1066.

At step 1066, the website system can determine already known visitor segments for target segment categories. In one embodiment, website system can determine the visitor segments in the session data or elsewhere. Thus, for example, if the target segment categories are Locale, BrowserType and Gender, the website system can determine if the visitor is associated with a BrowserType, Gender or Locale in the session data or visitor profile.

If there are remaining target segment categories for which the visitor session data does not provide a segment, the page generator module can send a request to a segment provider (step 1068) to request visitor segments corresponding to the website visitor and receive the visitor segments in response (step 1070). For example, if a target segment is Locale:England, but the visitor session data does not include a value for Locale, the page generator module can send a request to the segment provider to request the visitor segment for the Locale associated with the visitor and receive a Locale segment in response. The website system can update the visitor session data in the session information with the received visitor segments (step 1072).

The page generator module can process the request associated with the website visitor for the segment dependent web page using the visitor segments associated with the website visitor provided by the segment provider to generate web page files for the segment dependent web pages. In general, page generator module can generate web page files based on applying targeting rules associated with the requested segment dependent web page to the visitor segments.

In one embodiment, the page generator module can compare the visitor segments associated with the website visitor to the target segments to determine matches (step 1074). At step 1076, the website system can generate the web page files according to the targeting rules and based on the matches between visitor segments and target segments.

According to one embodiment, if a visitor has a specified segment for a target segment category that does not match the target segment for the segment category, the page generator module can consider the visitor to meet a default targeting rule. For example, i) if a targeting rule references the target segment Age:30-45; ii) no other targeting rules for the segment category Age are specified for that aspect of the web page; and iii) the visitor segment is Age:20-29, the visitor can be considered to fall under a default rule for the aspect of the web page affected by the targeting rule. A default rule can also be used if there is insufficient information to determine the visitor segment corresponding to a target segment category.

Referring to FIG. 10B, if the page generator module is operating in an impersonation mode, the page generator module can process the requests associated with the website visitor for the segment dependent web page using impersonated user segments specified by a user to generate the web page files. According to one embodiment, the page generator module can apply the set of targeting rules to the impersonated user segments to generate the web page files.

In the impersonation mode, the page generator module can determine the impersonated user segments from the session data that match target segments (step 1078). Thus, for example, if the target segment categories are Locale, BrowserType and Gender, the website system can determine if the session data or an impersonated user profile specifies segments for BrowserType, Gender or Locale.

If there are impersonated user segments for all the target segment categories, the website system can compare the impersonated user segments to the target segments (step 1080) and generate web page files based on the results (step 1082). If an impersonated user has a specified segment for a target segment category that does not match a target segment, the website system can generate the web page according to a default rule for the aspect of the web page affected by the targeting rule. Thus for example, if the only target segment applied to an aspect of the web page is BrowserType:Mobile and the impersonated user data includes a segment of BrowserType:Desktop, the resulting aspect of the web page can be processed based on a default rule.

If the selected impersonated user profile does not specify segments for all the target segment categories for a web page, the page generator module can identify a first set of remaining segment categories. The first set of remaining target segment categories comprises target segment categories for which there is no corresponding impersonated user segment in the set of impersonated user segments.

For the first set of remaining target segment categories, the page generation module can determine if there are any visitor segments corresponding to the target segment categories in the first set of remaining target segment categories (step 1084). In one embodiment, website system can determine the visitor segments for the target segment categories from visitor session data in the session information, a visitor profile or elsewhere.

If there are still remaining target segment categories (a second set of remaining target segment categories that is a subset of the first set of remaining target segment categories) for which the visitor session data (or profile data) does not provide a segment, the page generation module can send a request to a segment provider (step 1086) and receive the visitor segments corresponding to the target segment categories in the second set of remaining target segments (step 1088). The website system can update the visitor session data with the visitor segments (step 1090).

At step 1092, the website system can compare the impersonated user segments to the target segments and, for the target segment categories for which there are no impersonated user segments specified, compare the corresponding visitor segments to the target segments to determine matches. The website system can generate the web page files based on the results (step 1082). If there is a target segment category applied to an aspect of the web page for which no impersonated user segment or visitor segment can be determined, the website system can process the aspect of the web page affected by the targeting rule according to a default rule. The steps of FIGS. 10A and 10B can be repeated as needed or desired, additional steps added, the steps performed in other orders and some steps omitted.

As noted above, operating in impersonation mode may be beneficial for website testing. Accordingly, a website system that operates in an impersonation mode of operation may be implemented as part of a website development system. FIG. 11 is a diagrammatic representation of one embodiment of a website development system 1100. Website development system 1100 comprises client computer 1122, a development server 1124 and a segment provider server 1130. Client computers 1122 and development server 1124 are connected by a transmission channel 1134 and development server 1124 and segment provider server 1130 connected by a transmission channel 1135. Transmission channels 1134 and 1135 can be any suitable transmission channel including a LAN, WAN, the internet or other transmission channel.

Development server 1124 can be coupled to a production system 1128. Production system 1128 can be coupled to the Internet or an intranet. When a website is ready to be made available over the World Wide Web, development server 1124 can send the website to production system 1128 and production system can make it available over the Internet or other target network.

Client computer 1122 can be a standard computer including a central processing unit (“CPU”) 1131 connected to a computer readable medium 1132 (primary and/or secondary). Computer readable medium 1132 can comprise any combination of RAM, ROM and/or a magnetic storage device such as a hard drive or other non-transitory computer readable storage medium. Client computer 1122 establishes network communications through a network connection device 1133.

Computer readable medium 1132 stores a number of computer programs, including a development application 1136 used to communicate with development server 1124, to visually present the information received from development server 1124 and to allow the user to interact with information received from development server 1124. According to one embodiment, development application 1136 can be a web browser running an Adobe Flash program, a Java program, a scripting language application, or an AJAX (Asynchronous JavaScript and XML) application operating in a web browser runtime environment, or be standalone program. \

Development server 1124 can include server computer components, including a network connection device 1140, a CPU 1142, and a non-transitory computer readable medium 1144 primary and/or secondary memory, disk drives or other non-transitory computer readable media). Development server 1124 can act as a web server running a web server program 1147 to provide a web server module 1148 to process HTTP requests (or other requests) from client 1122. Development server 1124 can further include a website development server application 1150 that can be executed to provide a page generator module 1152 and a segment provider interface. Furthermore, development server can execute a content management system program 1165 to provide a content management system module (CMS) 1166. Thus, development server 1124 may be a web server, an application server and content management system internally coupled through shared hardware and processing. In other embodiments, the functionality of development server 1124 may be distributed between one or more web servers, application servers and content management systems coupled across networks or otherwise.

According to one embodiment, development server 1124 may maintain a repository 1170 of website assets. The collection of assets in site repository 1170 may include file assets and non-file assets for one or more websites. Non-file assets include assets defining users, groups, modules, module types, pages, menus, themes, structures, styles and templates, logon permissions, administrative permissions, site branding, site content, site navigation, instantiated programming language objects, permissions, user preferences and settings. File assets may include resources such as code including JSP pages, ASP pages, Java classes and/or object oriented programming language classes, and images including GIF files, etc.

Segment provider server 1130 can include server computer components, including a network connection device 1172, a CPU 1174, and a non-transitory computer readable medium 1176 (primary and/or secondary memory, disk drives or other non-transitory computer readable media). Segment provider server 1130 runs a segment provider application 1178 that responds to requests from development server 1124 for segments. While shown as separate, a segment provider may be provided internal to development server 1124. Moreover, development server 1124 may communicate with multiple segment providers including internal and external segment providers.

In operation, development application 1136 can request information or initiate actions at development server 1124 by sending URL requests to server 1124. These requests can be translated into requests to page generator module 1152. Page generator module 1152 can make calls to CMS 1166 to request data to request data to build a file for the requested web page (e.g., an HTML, XML or other file). Preferably, page generator module 1152 builds the file to provide a production view of the web page. Page generator module 1152 can further create the web page file so that tools and other information are overlaid on the production view to allow in-context editing of the web page as described in U.S. patent application Ser. No. 13/280,951, entitled “System, Method and Computer Program Product for Editing Web Pages In-Context of a Production View”, filed Oct. 25, 2011, which is hereby fully incorporated by reference herein.

In some cases, the web page file may be a fragment of a web page. Accordingly, web server module 1148 may receive multiple fragments from page generator module 1152 and/or from cache and assemble the fragments into a final web page file that web server module 1148 returns to client 1122. The content and layout of the web page in the view, according to one embodiment, can mimic that of a production view (e.g., a view as provided by production system 1128).

As discussed above, a web page may be segment-dependent. Consequently, requests for the same web page by different users using different browsers, etc. may result in different content, different formatting or other differences in the instance of the web page returned. This makes it difficult to fully test a website in typical systems as the website developer must establish users having different user profiles and access the website across different sessions under those user profiles using different browsers, etc. to fully test all the possible combinations of segments for each page.

To reduce these difficulties, page generator module 1152 can operate in an impersonation mode of operation. In the impersonation mode of operation, the page generator module 1152 can use the segments specified by the client and, for unspecified segments, generate the page according to defaults or request the appropriate segments from the segment provider. The segments specified by the client can be different than the segments that would otherwise be provided by the segment provider for a session visitor.

In one embodiment, a visitor, such a website developer using a web browser, can log into a site under development using credentials. The session information for the user will correspond to that visitor's profile at the website, the browser being used, etc. If the visitor requests a segment-dependent web page from the site, and page generator module 1152 is not in an impersonation mode, page generator module 1152 will request segments from the segment provider corresponding to the session information and build the appropriate file(s).

On the other hand, if page generator module 1152 is in the impersonation mode, website development module can use impersonated segment information explicitly provided by the client (regardless of whether that segment information matches the segment information that would be returned by the segment provider based on the visitor session information) to build the web page file(s). The impersonated segment information, according to one embodiment, may be loaded from an impersonation profile and placed in the session information associated with the visitor.

In another embodiment, the client may specify impersonated user segments to use in the URL request. When the page generator module 1152 processes the requests, page generator module 1152 can use impersonated segment information from the request to build the web page file(s) for the instance of the requested web page.

Before continuing, it may be helpful to describe one embodiment of the organization of website assets in repository 1170. According to one embodiment, website assets may be organized according to an object-model. Examples of objects include:
a. Site: A “site” object refers to a logical container for content instances and channels representing a site structure. A site object serves as the definition of the online endpoint (which can be a website) for content published to the web.
b. Channel: A “channel” object refers to a logical node in a site structure to which content items can be associated. In this context, “channels” can be used to organize and manage user access to managed content. As a specific example, a website may have channels such as news, sports, entertainment, etc., each being defined by a channel object in the site navigation tree of the website and accessible by visitors of the website through, for instance, a page or a link in the website domain.
c. Content type: A “content type” object contains a logical definition for a piece of structured content. In some embodiments, a website development system may support content types that meet common content management and presentation management requirements (e.g., Images, Videos, Pages, Regions, Components, Themes, and more.)
d. Segment content type: A “segment content type” object is a logical definition of a segment and is capable of project containment and reference, but can be restricted from all other management aspects. One embodiment of a segment content type object can be defined as follows:

String name; // the provider-defined segment identifier
String provider; // the provider name
// unique key <provider, name>
// default label: <name>

e. Impersonation profile content type: An “impersonation profile content type” object is a logical definition of an impersonated user profile and is capable of project containment and reference, but can be restricted from all other management aspects. One embodiment of an impersonation profile content type object can be defined as follows:

String name; // user-defined profile name
String description; // user-defined description
File Thumbnail
List<Segment> segments; // user-selected segments
// unique key <name>
// default label: <name>

f. Content instance: A “content instance” object refers to an individual piece of content created from a given content type definition (contained in a “content type” object).
g. Static file: A “static file” object refers to any individual file uploaded and managed by the content management system.

Each of the objects types listed above can be defined by a variable number of attributes (e.g., name and description are default attributes for each object) with default settings which can be configured if needed. Those skilled in the art will appreciate that the objects types listed above are meant to be exemplary and non-limiting and that additional object types not listed here are possible and anticipated.

Instances of the object types above are called “managed objects”, which obey a number of predetermined rules and properties when it comes to the content life cycle and the security model (e.g., logical placement in the repository, approval and publishing rules, etc.). Each instance of an object may include metadata such as: a global unique identifier (GUID), security related information (e.g., access control list), creation date, creator, modification date, modifier, path within a content hierarchy, approval status, publishing status, scheduled publish and unpublish dates and other metadata.

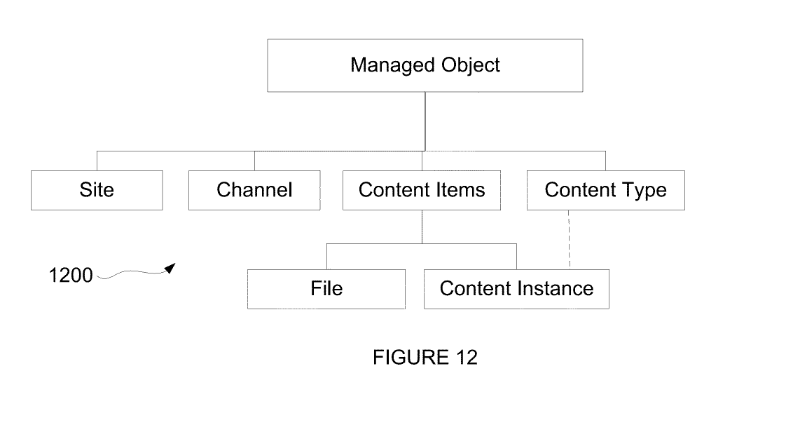

From a class hierarchy standpoint, these object instances can be represented in a content management object model. Referring now to FIG. 12, FIG. 12 depicts a diagrammatic representation of an example content management object model 1200. Content management object model 1200 may be utilized to manage content for websites. A “content item” may represent a piece of content that is either of the “content instance” or of the “static file”. Content items can be stored as corresponding content objects in a repository (e.g., such as repository 1170 of FIG. 11). In some cases, rather than storing the content items, the repository can include references to another system and its corresponding objects or repository.

Each content item (content instance or file) can have an arbitrary amount of metadata associated with it. For purposes of website management, such metadata may include site and channel associations, a list of categories, a list of dependencies (other items referring to the current one, all items referred to by the current one), workflow history, locking status (e.g., to prevent concurrent editing), whether the content object has been approved for publication, whether it was published, or any other information that is useful in classifying the content object for website management.

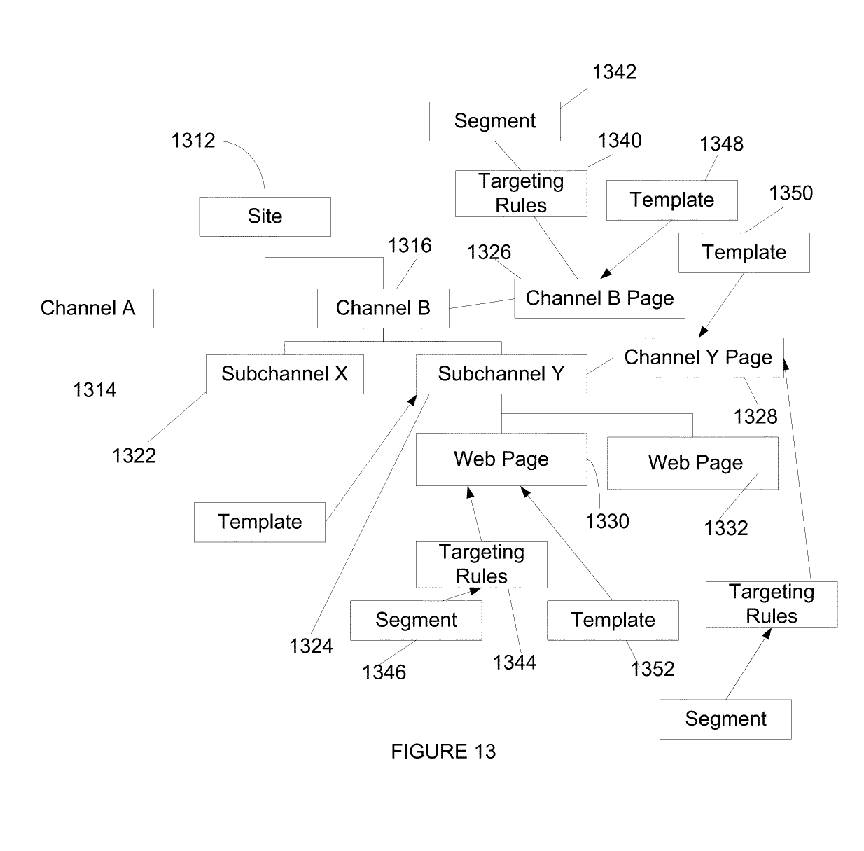

Using an object model, a web page definition may be defined through one or more content instances, files and objects. Referring to FIG. 13, a hierarchal model for an example website is illustrated. A site object 1312 can be defined that acts as a container for a set of channels. In this example, the website includes two main channels, “Channel A” and “Channel B”, represented by channel object 1314 and channel object 1316 respectively. Channel B has two subchannels, “Channel X” and “Channel Y” represented by channel object 1322 and channel object 1324 respectively.

According to one embodiment, channel pages can be defined to represent the content common to pages in the channel such as navigation information, branding, links or other content. Channel pages can be defined for any level of channel. In the example of FIG. 13, a channel page content item 1326 is defined for Channel B and a channel page content item 1328 is defined for Subchannel Y. Although the pages are shown as single content items, a page content item may reference any number of other content items. Web page content items can be also be defined for displaying specific pieces of web content and be associated with the channels. For example, web page content objects 1330 and 1332 can be defined and associated with Subchannel Y. Each web page content object may refer to any number of other web page content items.

The usefulness of channel pages can be seen in the context of a website that provides multiple forms of information, appeals to multiple interests or is tailored for multiple locales. Using the example of a news site, Channel A can be a “Politics” channel and Channel B a “Sports” channel. Furthermore, Subchannel X can be “Football” channel and Subchannel Y can be a “Hockey” channel. All the web pages corresponding to Channel B can include the navigation information and other content specified in the Channel B page content object 1326 regardless of whether they are Football or Hockey related pages. Similarly, all the Hockey related pages can further include the content, navigation information, etc. specified in the Channel Y page content object 1328. The web page content items 1330 and 1332 may define how portions of a web page containing hockey story items are displayed.

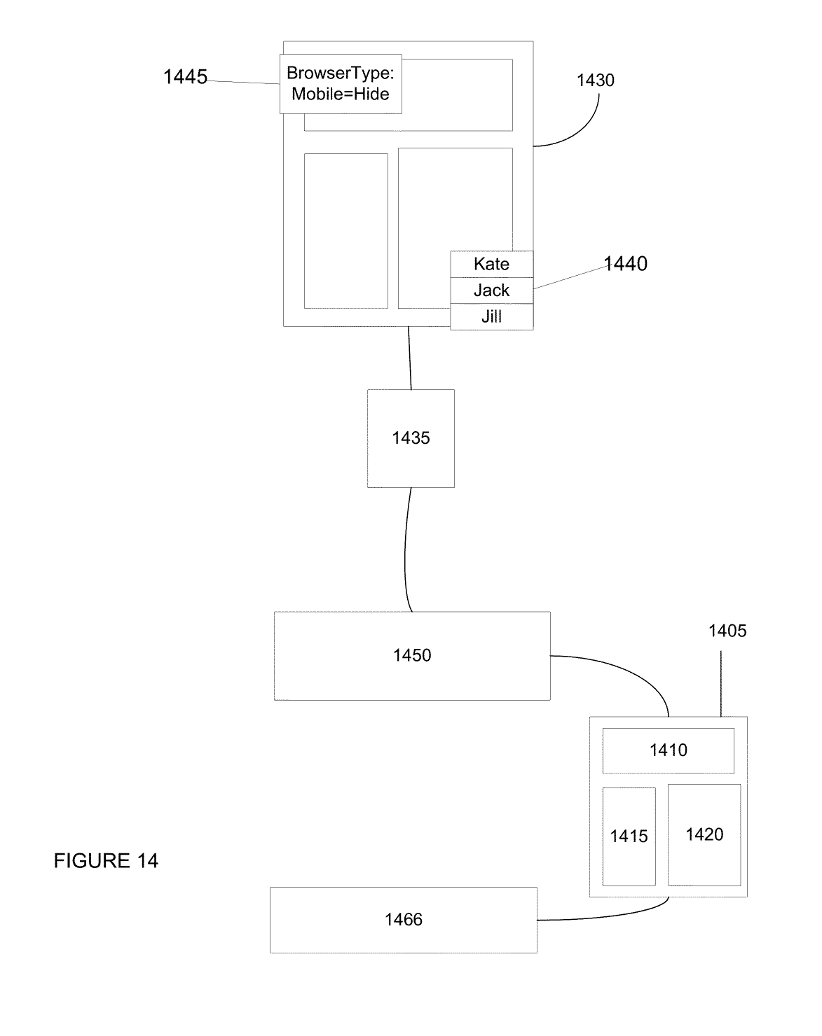

Any level of the site hierarchy may include targeting rules creating segment dependencies. For example, channel page content object 1326 may be associated with targeting rules 1340 referencing segment 1342 and web page content object 1330 may be associated with targeting rules 1344 referencing segment 1346. Furthermore, each level of web page content objects in the site hierarchy may be associated with a template. A template provides a pattern for pages. Thus, for example, web page content object 1326 can be associated with template 1348, web page content object 1328 can be associated with template 1350, web page content object 1330 can be associated with template 1352. According to one embodiment, page templates are assigned to content types so that new content items created from that type are associated with the appropriate page template. One example of a template is discussed below in conjunction with FIG. 14.

Referring still to FIG. 13, in operation, when a visitor requests a web page, the page generator module can traverse the objects associated with the web page including the site object, channel objects, content instances to determine the content, formatting and other aspects of the web page including the segment dependencies. For example, if a user requests a web page corresponding to content object 1330, the page generator module can analyze site object 1312, channel object 1316, subchannel object 1324, page content object 1326, page content object 1328 and page content object 1330 to determine that the instance of the requested web page is dependent on segment 1342 and segment 1346. However, if targeting rules are only defined at certain levels of the hierarchy leading to the web page, it is not necessary to traverse the entire hierarchy to determine target segments, though it may be to determine other metadata, depending on implementation. Thus, for example, if targeting rules are only defined on content object 1330, then only content object 1330 would need to be analyzed to determine the target segments for requests for a web page corresponding to content object 1330.

FIG. 14 is a diagrammatic representation of one embodiment of providing a web page to a user. In general, website development server application 1450 can request content for the web page from CMS 1466 to build the web page. In one embodiment, a web page is laid out according to a template, such as template 1405. Template 1405 provides a pattern for the web page. A template defines regions (e.g., regions 1410, 1415 and 1420) that define where content appears in the page. Each region can be populated by one or more components including, but not limited navigation components, text components, content items, content lists, images, smart lists, or other components. Template 1405 can also specify what actions are available for a component (e.g., change, move, remove or other action).

Based on template 1405, website development server application 1450 can generate a web page file 1435 to send to a browser to cause the browser to render a view 1430 of the web page. This may include causing the browser to execute scripts, make additional requests or take other actions used to render web pages.

When a web page is accessed, website development server application can build a web page file 1435 that will cause a browser to render a production view of the web page with an overlay of editing tools. According to one embodiment, the tools can be overlaid as a “div” overlay through CSS.

Website development server application 1450, can parse template 1405 to determine the regions where components are placed. For each region and/or component in a region, the types of actions that are available can be determined. This can be based on metadata associated with the template, metadata associated with the components or other information. Website development server application 1450 can change the DOM and HTML of the web page to include information for the editing tools in web page file 1435.

According to one embodiment, a JavaScript library is provided to parse the template and attach the corresponding editing tools to each component or region. The tools themselves can be rendered and positioned using World Wide Web Consortium (W3C) standards such as CSS and JavaScript. Because the tools are rendered in the browser environment, they can be easily enabled or disabled without needing a full page refresh.

According to one embodiment, tools can include a set of tools to allow editing of the overall page or template, tools to select an impersonation profile (represented at 1440) and other tools. In one embodiment the various tools can be overlaid on view 1430 so that they do not distort the production view.

Furthermore, in the development environment, the regions or components can be selectable to allow a user to specify targeting rules for the region or components. The rules can be stored as objects in the website repository linked to region objects utilized referenced the web page. When a user selects a region, the targeting rules in effect for the region or component may be shown (represented at 1445).

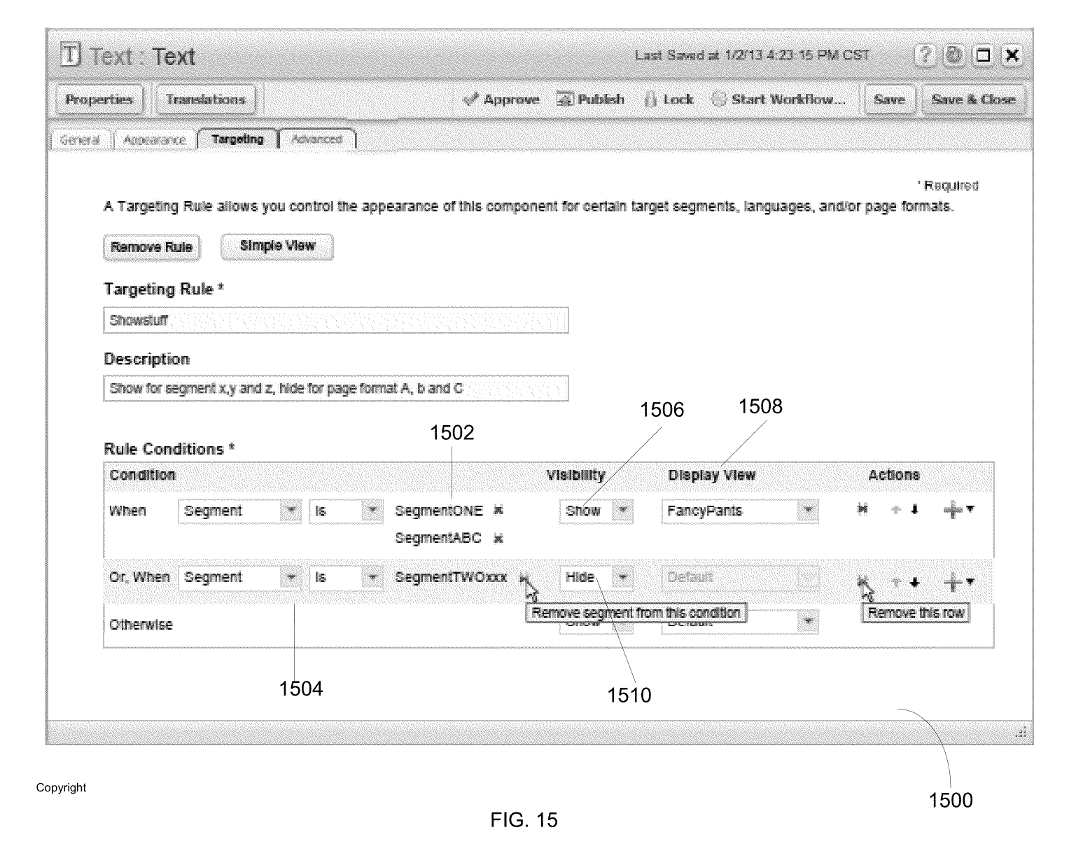

FIG. 15 is a diagrammatic representation of one embodiment of a GUI 1500 for specifying targeting rules for a content item. According to one embodiment, the ability to specify targeting rules can be accessed by selecting a region or component in a web page view or by selecting corresponding content items in the repository.

In the example of FIG. 15, the user has selected a text component and specified a multi-conditional targeting rule. When a visitor segment is “SegmentOne” or “SegmentABC” (indicated at selection 1502), the text component will be shown (indicated at selection 1506) using a specified display view (in this case a display view named “FancyPants”) (indicated at selection 1508). However, if the visitor segment is “SegmentTWOxxx” (indicated at selection 1504), the text component will be hidden (indicated at selection 1510).

In this example, SegmentOne, etc. may be a user defined container for a group of target segments. For example, SegmentOne may map to BrowserType:Mobile, Age:30-45, Gender:Male. This can make it easier to define targeting rules for visitors sharing multiple common features without having to repeatedly specify the segments for each rule.

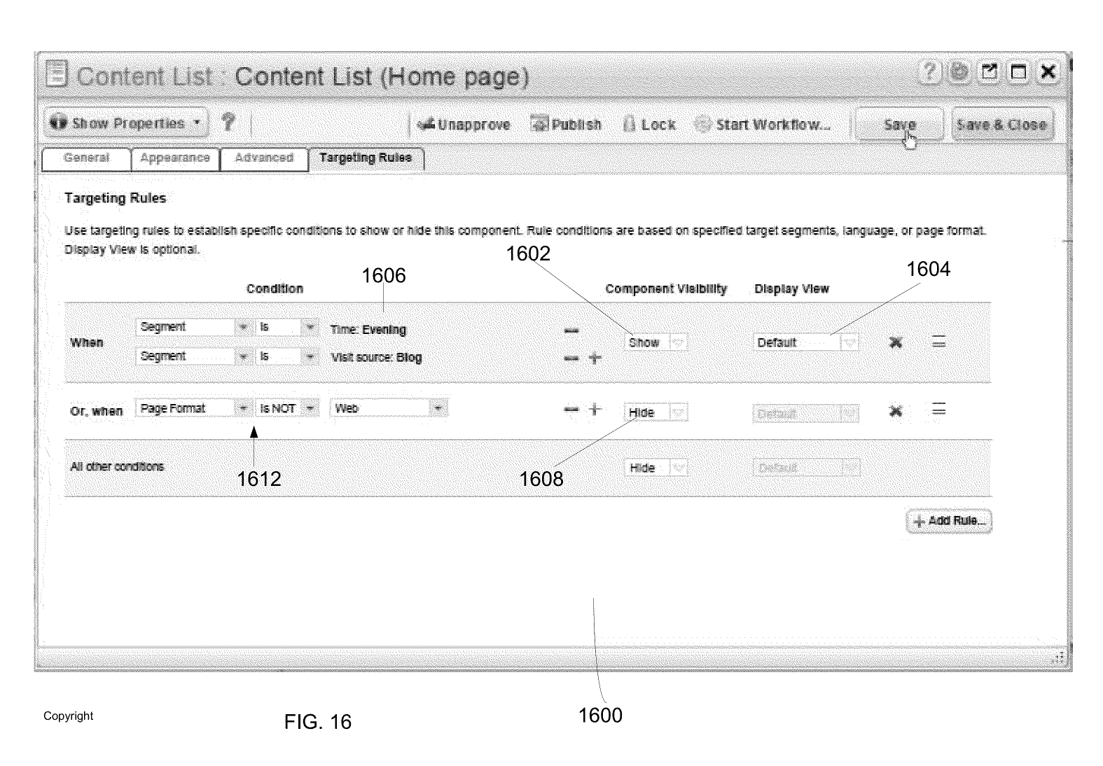

FIG. 16 is a diagrammatic representation of another embodiment of a GUI 1600 illustrating targeting rules. In the embodiment of FIG. 16, the user has specified that the content item “content list” should be shown (represented at selection 1602) in a default view (represented at selection 1604) when the visitor is associated with the segments Time:Evening and Visit Source:Blog (represented at selection 1606). However, the content item should be hidden (represented at selection 1608) when the page format is not “Web” (represented at selections 1612). The targeting rules may include any number of AND/OR conditions and may include conditions such as effective date ranges and other conditions. Furthermore, a user may assign priorities between rules or conditions within rules.

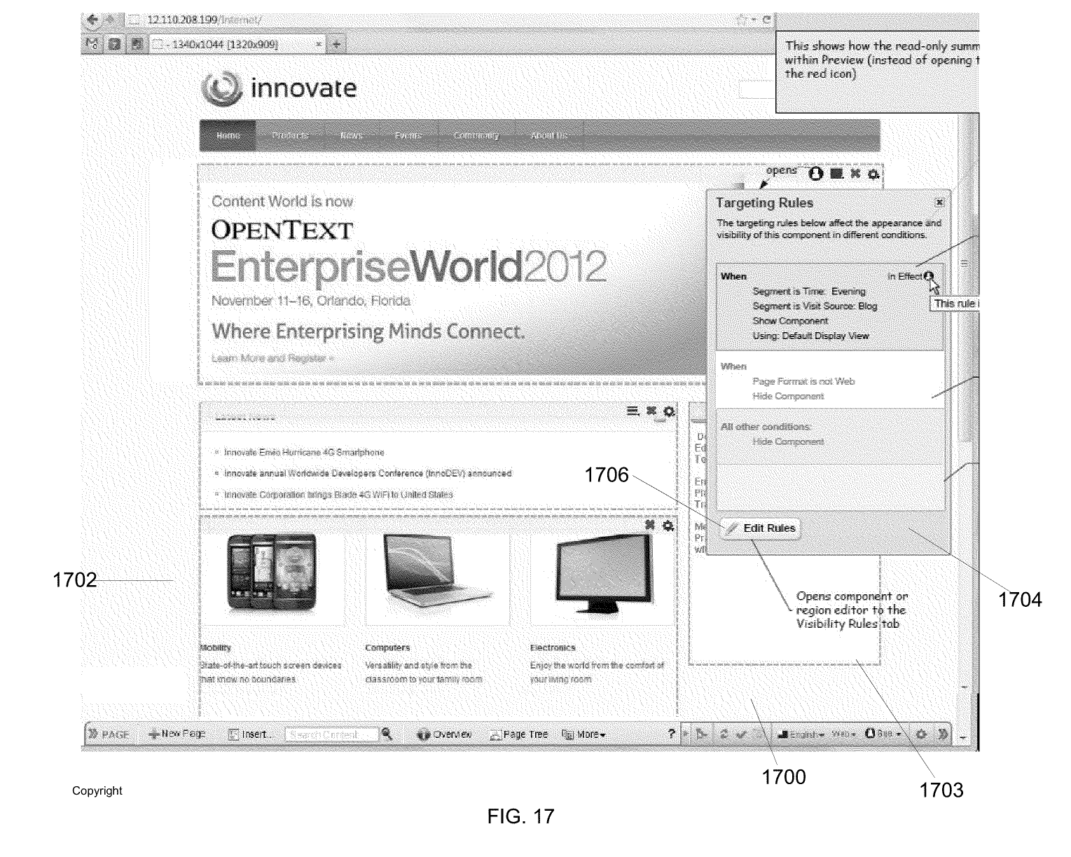

FIG. 17 is a diagrammatic representation of one embodiment of a GUI 1700 that can be provided in a website development application to display targeting rules in-context of a production view of a web page. In the example of FIG. 17, an underlying web page view 1702 is displayed that appears similar to a production view of the web page but with various region and component boundaries and tools overlaid. When a user selects a component or region, the targeting rules for that component or region can be displayed. For example, if the user selects component 1703, targeting rules display 1704 can be presented showing the targeting rules. If the user selects edit rules button 1706, the user can be presented with a GUI to edit the targeting rules. In the example of FIG. 17, the user can be presented with the GUI of FIG. 16.

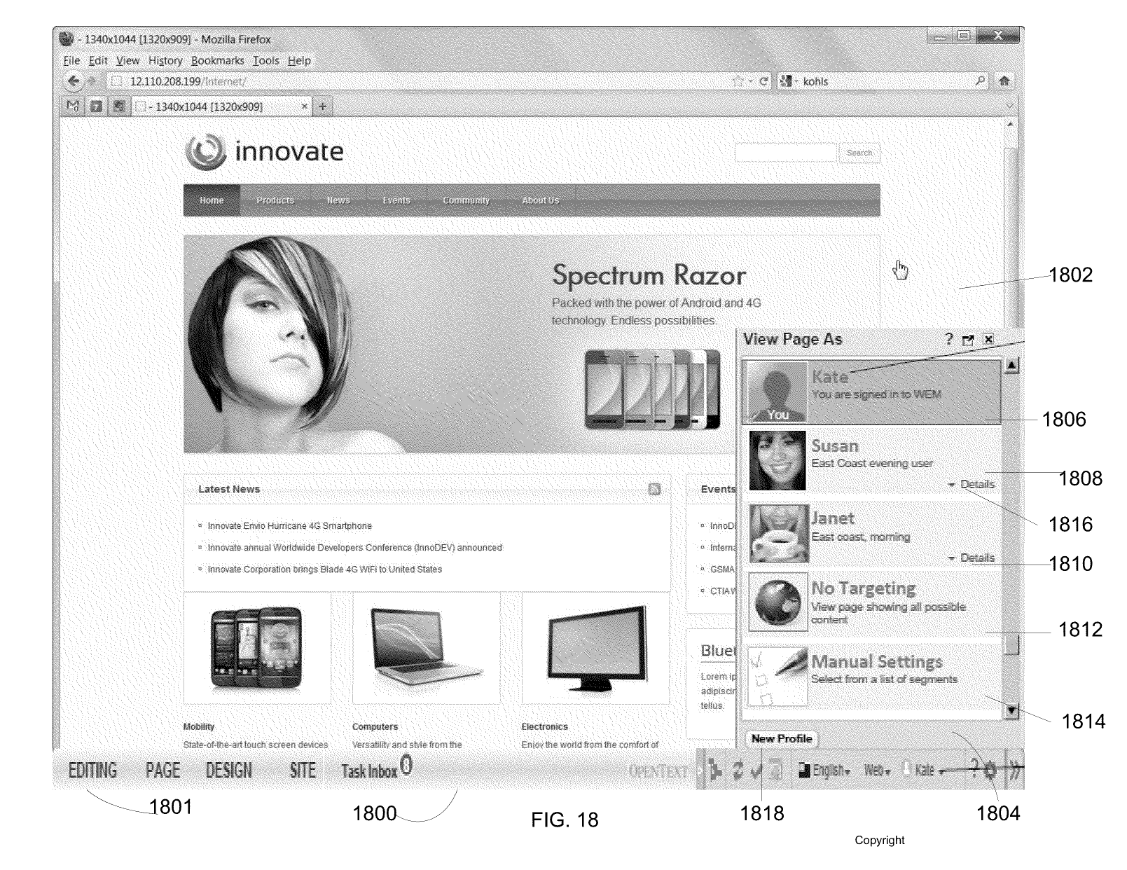

FIG. 18 is a diagrammatic representation of one embodiment of a GUI 1800 that can be provided to allow selection of an impersonation profile. GUI 1800 can provide an underlying web page view 1802. In the example of FIG. 18, web page view 1802 can be a production view or similar to a production view of the web page. The webpage can have tools 1801 overlaid. If the visitor selects impersonation tools, the user can be presented with an impersonation display 1804 listing available options for impersonation. Impersonation display 1804, in one embodiment, can be overlaid on web page view 1802.

If the visitor is logged in to the web site, impersonation display 1804 can display a representation of the visitor's profile. In this example, “Kate” is the visitor accessing a development version of the web site (represented at area 1806). Representations of available impersonation profiles may also be shown. For example, impersonation display 1804 includes profiles for impersonated user's “Susan” (shown in area 1808) and “Janet” (shown in area 1810). The visitor may also select a “No Targeting Profile” (shown in area 1812) in which the web site will not apply targeting rules but will display all possible content for a web page and a “Manual Settings” option (shown in area 1814) which allows a user to manually select impersonated user segments. The visitor can interact with impersonation display 1804 to select various options.

The various areas in impersonation display 1804 can be interactively expandable to show more information. According to one embodiment, if a user selects a “details” option, the user can be provided additional information about an impersonated user profile. Thus, if the user selects “details” option 1816, the user will be provided additional information about impersonated user profile Susan. The user can also select to provide a new profile by selecting button 1818.

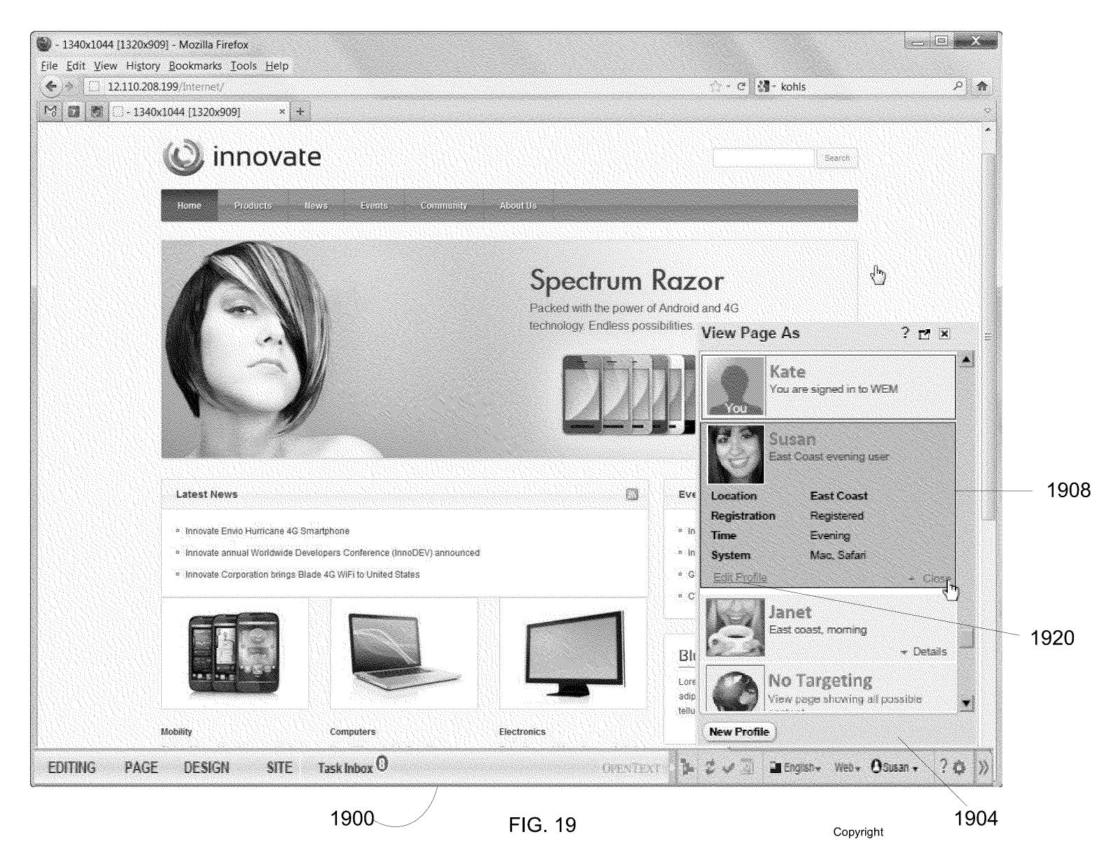

FIG. 19 is a diagrammatic representation of a GUI 1900 illustrating a state of one embodiment of an impersonation display 1904 when the user selects the “details” option 1816 of FIG. 18. In this case, the segments for the impersonated user profile Susan are displayed showing the following impersonated visitor segments Location:East Coast, Registration:Registered, Time:Evening, System:Mac, System:Safari. As can be seen in this case, a user may fall into multiple segments for a segment category. If Kate selects the impersonated user profile Susan (e.g., by clicking on area 1908), Susan's impersonated user data can be added to the session data for Kate and the targeting rules for requests from Kate will be evaluated using the impersonated user segments of Susan. FIG. 19 also illustrates that a user may select to edit an impersonated user profile by selecting edit profile option 1920.

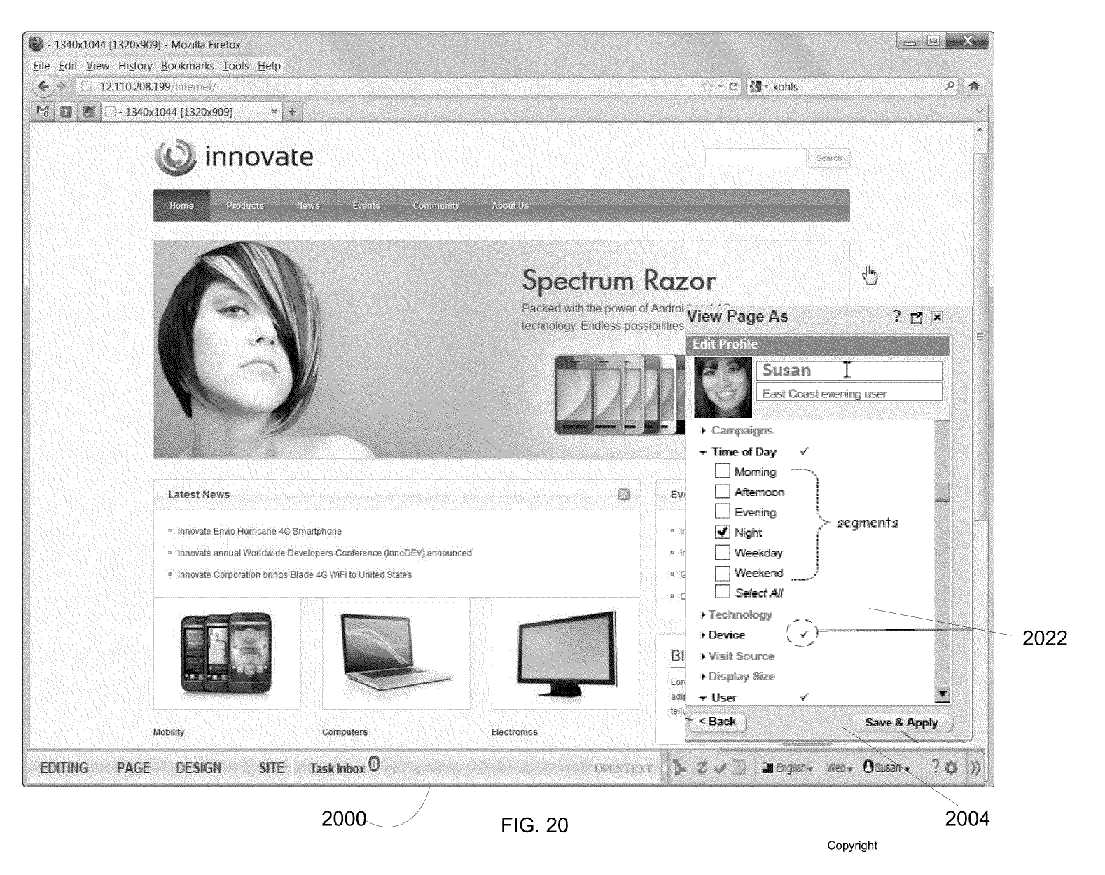

FIG. 20 is a diagrammatic representation of a GUI 2000 illustrating a state of one embodiment of impersonation display 2004 when the user selects the “edit profile” option 1920 of FIG. 19. Impersonation display 2004 can display segment selection menu 2022 for the user profile. According to one embodiment, segment selection menu 2022 may be interactively expandable by segment type to allow a visitor to select the impersonated user segment for that type. For example, the visitor can select that Susan's profile is associated with the Time of Day:Night segment and make other selections. According to one embodiment, the segments displayed in segment selection menu can include all the segments available for the website or some subset thereof (e.g., restricted by visitor permissions or other factors).

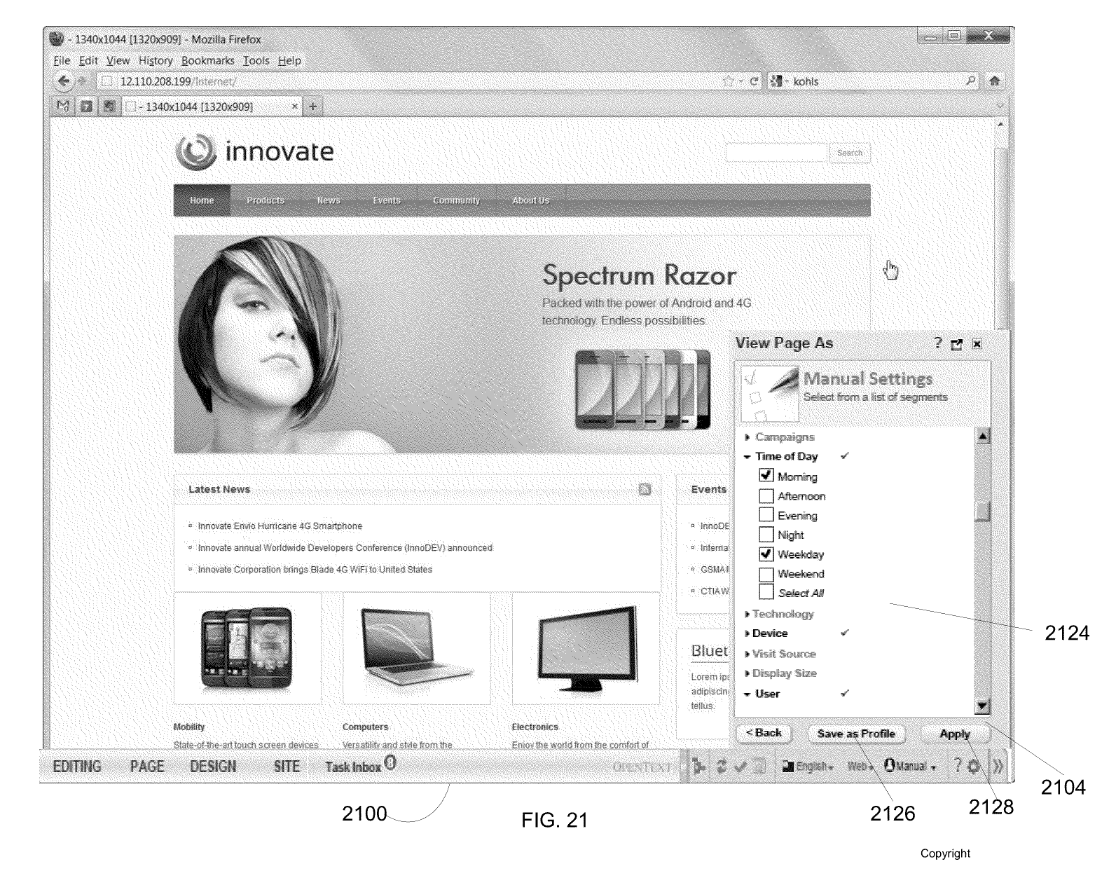

FIG. 21 is a diagrammatic representation of a GUI 2100 illustrating a state of one embodiment of impersonation display 2104 when the user selects to manually select segments (e.g., by selecting area 1814 of FIG. 18). Impersonation display 2104 can display segment selection menu 2124 for selecting segments. According to one embodiment, segment selection menu 2124 may be interactively expandable by segment type to allow a visitor to select the impersonated user segment for that type. For example, the visitor can select the impersonated user segments Time of Day:Morning, Time of Day:Weekday, particular devices, etc. According to one embodiment, the segments displayed in segment selection menu can include all the segments available for the website or some subset thereof (e.g., restricted by visitor permissions or other factors).

The user may select to save the selections as a new profile (e.g., by selecting “save as profile” button 2126). In another embodiment, the user may select to apply the segments (e.g., by selecting the “apply” button 2128). According to one embodiment, if the user applies the selections, the selections can be added to the session information for the visitor as impersonated user data, but a new profile is not created.

As discussed above, in various embodiments, segments made available for selection can be provided by a segment provider. The segment provider module can be internal or external to the website system and may include segment provider modules controlled by third parties. According to one embodiment, a page generator module may treat segment providers as configurable resources that define segments in a pluggable framework. The framework defines a provider specific “factory” interface that provides methods to obtain other, provider-specific subinterfaces.

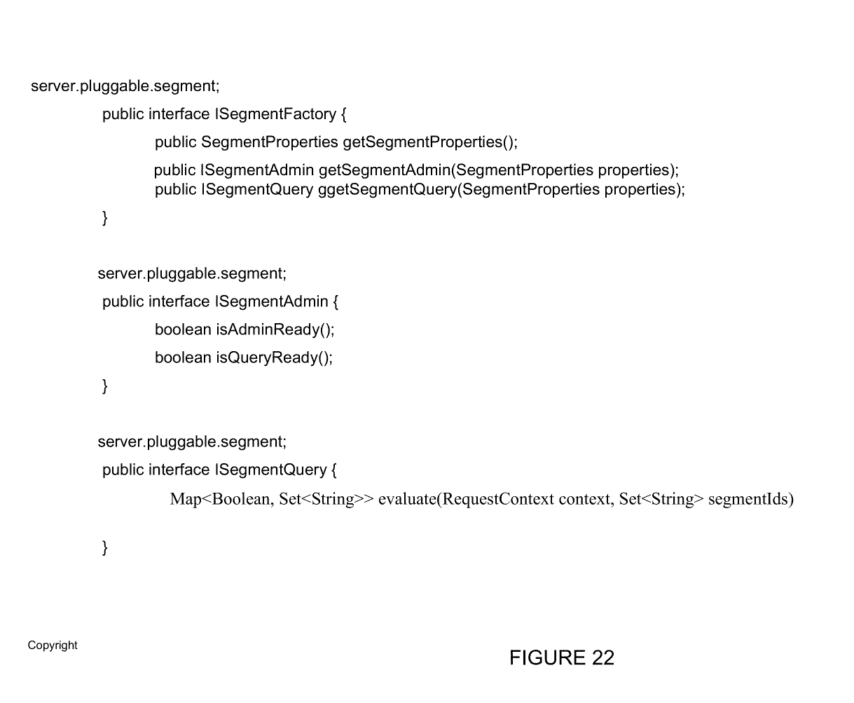

Referring to FIG. 22, FIG. 22 illustrates one example of an interface in a pluggable framework. In the example of FIG. 22, SegmentProperties encapsulates provider-dependent properties, used for dependency injection into the subinterfaces. This strategy facilitates integrating after-market, custom segment providers that need not contain knowledge of the website system server. The ISegmentAdmin can provide for monitoring/diagnostic for segment providers. The ISegmentQuery is the primary subinterface. It defines methods to obtain all potential segments for defining targeting rules and impersonated user profiles. It also defines method used to obtain the subset of segments to which a given request belongs for targeting rule evaluation and page rendering. The interface of FIG. 22 is provided by way of example and other interfaces may be used.

Reference throughout this specification to “one embodiment,” “an embodiment,” or “a specific embodiment” or similar terminology means that a particular feature, structure, or characteristic described in connection with the embodiment is included in at least one embodiment and may not necessarily be present in all embodiments. Thus, respective appearances of the phrases “in one embodiment,” “in an embodiment,” or “in a specific embodiment” or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the invention.

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

Embodiments of the present invention can be implemented in a computer communicatively coupled to a network (for example, the Internet, an intranet, an internet, a wide area network (WAN), a local area network (LAN), a storage area network (SAN), etc.), another computer, or in a standalone computer. As is known to those skilled in the art, the computer can include a central processing unit (“CPU”) or processor, at least one read-only memory (“ROM”), at least one random access memory (“RAM”), at least one hard drive (“HD”), and one or more input/output (“I/O”) device(s). The I/O devices can include a keyboard, monitor, printer, electronic pointing device (for example, mouse, trackball, stylist, etc.), or the like. In embodiments of the invention, the computer has access to at least one database over the network.

ROM, RAM, and HD are computer memories for storing computer-executable instructions executable by the CPU or capable of being complied or interpreted to be executable by the CPU. Within this disclosure, the term “computer readable medium” is not limited to ROM, RAM, and HD and can include any type of data storage medium that can be read by a processor. For example, a computer-readable medium may refer to a data cartridge, a data backup magnetic tape, a floppy diskette, a flash memory drive, an optical data storage drive, a CD-ROM, ROM, RAM, HD, or the like. The processes described herein may be implemented in suitable computer-executable instructions that may reside on a computer readable medium (for example, a disk, CD-ROM, a memory, etc.). Alternatively, the computer-executable instructions may be stored as software code components on a DASD array, magnetic tape, floppy diskette, optical storage device, or other appropriate computer-readable medium or storage device.

Any suitable programming language can be used to implement the routines, methods or programs of embodiments of the invention described herein, including C, C++, Java, JavaScript, HTML, or any other programming or scripting code, etc. Other software/hardware/network architectures may be used. For example, the functions of the disclosed embodiments may be implemented on one computer or shared/distributed among two or more computers in or across a network. Communications between computers implementing embodiments can be accomplished using any electronic, optical, radio frequency signals, or other suitable methods and tools of communication in compliance with known network protocols.

Different programming techniques can be employed such as procedural or object oriented. Any particular routine can execute on a single computer processing device or multiple computer processing devices, a single computer processor or multiple computer processors. Data may be stored in a single storage medium or distributed through multiple storage mediums, and may reside in a single database or multiple databases (or other data storage techniques). Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. The routines can operate in an operating system environment or as stand-alone routines. Functions, routines, methods, steps and operations described herein can be performed in hardware, software, firmware or any combination thereof.

It is also within the spirit and scope of the invention to implement through software programming, operations, methods, routines or portions thereof described herein, where such software programming or code is stored in a computer-readable medium and can be operated on by a processor to permit a computer to perform any of the steps, operations, methods, routines or portions thereof described herein. Embodiments may be implemented in one or more digital computers executing programming instructions, by using application specific integrated circuits, programmable logic devices, field programmable gate arrays, optical, chemical, biological, quantum or nanoengineered systems, components and mechanisms may be used. In general, the functions of the invention can be achieved by any means as is known in the art. For example, distributed, or networked systems, components and circuits can be used. In another example, communication or transfer (or otherwise moving from one place to another) of data may be wired, wireless, or by any other means. Based on the disclosure and teachings provided herein, a person of ordinary skill in the art will appreciate other ways and/or methods to implement the invention.

A “computer-readable medium” may be any medium that can contain or store, the program for use by or in connection with the instruction execution system, apparatus, system or device. The computer readable medium can be, by way of example only but not by limitation, an electronic, magnetic, optical, electromagnetic, or semiconductor system, apparatus, system, device, or computer memory. Such computer-readable medium shall generally be machine readable and include software programming or code that can be machine readable (e.g., object code). Examples of non-transitory computer-readable media can include random access memories, read-only memories, hard drives, data cartridges, magnetic tapes, floppy diskettes, flash memory drives, optical data storage devices, compact-disc read-only memories, and other appropriate computer memories and data storage devices. In an illustrative embodiment, some or all of the software components may reside on a single server computer or on any combination of separate server computers. As one skilled in the art can appreciate, a computer program product implementing an embodiment disclosed herein may comprise one or more non-transitory computer readable media storing computer instructions translatable by one or more processors in a computing environment.

A “processor” includes any hardware system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real-time,” “offline,” in a “batch mode,” etc. Portions of processing can be performed at different times and at different locations, by different (or the same) processing systems.

It will also be appreciated that one or more of the elements depicted in the drawings/figures can also be implemented in a more separated or integrated manner, or even removed or rendered as inoperable in certain cases, as is useful in accordance with a particular application. Additionally, any signal arrows in the drawings/figures should be considered only as exemplary, and not limiting, unless otherwise specifically noted.

As used herein, the terms “comprises,” “comprising,” “includes,” “including,” “has,” “having” or any other variation thereof, are intended to cover a non-exclusive inclusion. For example, a process, article, or apparatus that comprises a list of elements is not necessarily limited only those elements but may include other elements not expressly listed or inherent to such process, process, article, or apparatus.

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present). As used herein, including the claims that follow, a term preceded by “a” or “an” (and “the” when antecedent basis is “a” or “an”) includes both singular and plural of such term, unless clearly indicated within the claim otherwise (i.e., that the reference “a” or “an” clearly indicates only the singular or only the plural). Also, as used in the description herein and throughout the claims that follow, the meaning of “in” includes “in” and “on” unless the context clearly dictates otherwise. The scope of the present disclosure should be determined by the following claims and their legal equivalents.

Although systems and methods for website testing have been described with respect to specific embodiments thereof, these embodiments are merely illustrative, and not restrictive. The description herein of illustrated embodiments of the invention, including the description in the Abstract and Summary, is not intended to be exhaustive or to limit the systems and methods to the precise forms disclosed herein (and in particular, the inclusion of any particular embodiment, feature or function within the Abstract or Summary is not intended to limit the scope of the systems and methods to such embodiment, feature or function). Rather, the description is intended to describe illustrative embodiments, features and functions in order to provide a person of ordinary skill in the art context to understand the disclosure without limiting the systems and methods to any particularly described embodiment, feature or function, including any such embodiment feature or function described in the Abstract or Summary. While specific embodiments of, and examples for, are described herein for illustrative purposes only, various equivalent modifications are possible within the spirit and scope of the invention, as those skilled in the relevant art will recognize and appreciate. As indicated, these modifications may be made in light of the foregoing description of illustrated embodiments and are to be included within the spirit and scope of the invention. Thus, while the systems and methods have been described herein with reference to particular embodiments thereof, a latitude of modification, various changes and substitutions are intended in the foregoing disclosures, and it will be appreciated that in some instances some features of embodiments will be employed without a corresponding use of other features without departing from the scope and spirit of the invention as set forth. Therefore, many modifications may be made.

What is claimed is:

1. A system comprising:
a repository storing a web page definitions for segment dependent web pages;
a server coupled to the repository, the server configured to:
receive requests associated with a website visitor for segment dependent web pages;
determine whether to operate in an impersonation mode of operation or a non-impersonation mode of operation;
wherein in the non-impersonation mode of operation, the server is configured to:
request visitor segments corresponding to the website visitor from a segment provider;
receive the visitor segments corresponding to the website visitor from the segment provider; and
process the requests associated with the website visitor for segment dependent web pages using the received visitor segments associated with the website visitor to generate web page files for the segment dependent web pages based on applying a set of targeting rules to the visitor segments associated with the website visitor; and
wherein in the impersonation mode of operation, the server is configured to:
process the requests associated with the website visitor for the segment dependent web pages using impersonated user segments specified by a user to generate the web page files based on applying the set of targeting rules to the impersonated user segments.

2. The system of claim 1, wherein the server is further configured to allow the website visitor to specify the impersonated user segments by selecting an impersonated user profile.

3. The system of claim 2, wherein the server is further configured to determine a selected impersonated user profile selected by the website visitor and update session information associated with the website visitor with a set of impersonated user segments corresponding to the selected impersonated user profile.

4. The system of claim 3, wherein the server is configured to allow the website visitor to apply multiple impersonated user profiles within a context of a single session.

5. The system of claim 1, wherein in the server is configured to maintain a set of session information associated with the website visitor comprising a set of visitor session data and a set of impersonated user data.

6. The system of claim 5, wherein the visitor session data comprises information about the website visitor and wherein the set of impersonated user data comprises a set of impersonated user segments.

7. The system of claim 6, wherein the server is further configured to:
store visitor profiles for website visitors;
store an impersonated user profiles independent of the visitor profiles; and
load at least a portion of the visitor session data from a visitor profile associated with the website visitor; and
load at least a portion of the impersonated user data from a selected impersonated user profile.

8. A computer program product comprising a non-transitory computer readable medium storing a set of computer instructions executable by a processor to:
receive requests associated with a website visitor for segment dependent web pages:
determine whether to operate in an impersonation mode of operation or a non-impersonation mode of the operation;
in the non-impersonation mode of operation:
request visitor segments corresponding to the website visitor from a segment provider;
receive visitor segments corresponding to the website visitor from the segment provider; and
process the requests associated with the website visitor for segment dependent web pages using received visitor segments associated with the website visitor to generate web page files for the segment dependent web pages based on applying a set of targeting rules to the website visitor segments associated with the visitor;
provide the web page files for the segment dependent web pages to a web server; and
in the impersonation mode of operation:
process the requests associated with the website visitor for the segment dependent web pages using impersonated user segments specified by a user to generate the web page files based on applying the set of targeting rules to the impersonated user segments; and
provide the web page files for the segment dependent web pages to a web server.

9. The computer program product of claim 8, wherein the set of computer instructions further comprise instructions executable to provide a graphical user interface to allow the website visitor to specify the impersonated user segments by selecting an impersonated user profile.

10. The computer program product of claim 9, wherein the set of computer instructions further comprise instructions executable to determine a selected impersonated user profile and update session information associated with the website visitor with a set of impersonated user segments corresponding to the selected impersonated user profile.

11. The computer program product of claim 10, wherein the set of computer instructions further comprise instructions executable to allow the website visitor to apply multiple impersonated user profiles within a context of a single session.

12. The computer program product of claim 8, wherein the set of computer instructions further comprise instructions executable to maintain a set of session information associated with the website visitor comprising a set of visitor session data and a set of impersonated user data.

13. The computer program product of claim 12, wherein the visitor session data comprises information about the website visitor and wherein the set of impersonated user data comprises a set of impersonated user segments.

14. The computer program product of claim 13, wherein the set of computer instructions further comprise instructions executable to:
store visitor profiles for website visitors;
store an impersonated user profiles independent of the visitor profiles;
load at least a portion of the visitor session data from a visitor profile associated with the website visitor; and
load at least a portion of the impersonated user data from a selected impersonated user profile.

15. A method comprising
at a server, receiving requests associated with a website visitor for segment dependent web pages;
determining whether to operate the server in an impersonation mode of operation or a non-impersonation mode of the operation;
in the non-impersonation mode of operation:
requesting visitor segments corresponding to the website visitor from a segment provider;
receiving visitor segments corresponding to the website visitor from the segment provider; and
processing the requests associated with the website visitor for the segment dependent web pages at the server using the received visitor segments associated with the website visitor, wherein processing the requests further comprises generating a web pages files for the segment dependent web pages based on applying a set of targeting rules to the website visitor segments associated with the visitor; and
in the impersonation mode of operation:
processing the requests associated with the website visitor for the segment dependent web pages at the server using impersonated user segments specified by a user, further comprising generating the web page files based on applying the set of targeting rules to the impersonated user segments.

16. The method of claim 15 further comprising providing a graphical user interface to allow the website visitor to specify the impersonated user segments by selecting an impersonated user profile.

17. The method of claim 16 further comprising determining a selected impersonated user profile and updating session information associated with the website visitor with a set of impersonated user segments corresponding to the selected impersonated user profile.

18. The method of claim 17, further comprising allowing the website visitor to apply multiple impersonated user profiles within a context of a same session.

19. The method of claim 15, further comprising maintaining a set of session information associated with the website visitor comprising a set of visitor session data and a set of impersonated user data.

20. The method of claim 19, wherein the visitor session data comprises information about the website visitor and wherein the set of impersonated user data comprises a set of impersonated user segments.

21. The method of claim 20, further comprising:
storing visitor profiles for website visitors;
storing an impersonated user profiles independent of the visitor profiles;
loading at least a portion of the visitor session data from a visitor profile associated with the website visitor; and
loading at least a portion of the impersonated user data from a selected impersonated user profile.

22. A system comprising:
a repository storing a web page definitions for segment dependent web pages;
a state machine having a first state non-impersonation mode and a second state impersonation mode, the state machine configured to:
receive a request associated with a website visitor for segment dependent web page;
if a current state is the first non-impersonation mode of operation:
request visitor segments corresponding to the website visitor from a segment provider;
receive visitor segments corresponding to the website visitor from the segment provider; and
process the request associated with the website visitor for the segment dependent web page using visitor segments associated with the website visitor provided by the segment provider to generate a web page file for the segment dependent web page based on applying a set of targeting rules to the visitor segments associated with the website visitor; and
if the current state is the second state impersonation mode:
process the request associated with the website visitor for the segment dependent web page using impersonated user segments specified by the website visitor to generate the web page file based on applying the set of targeting rules to the impersonated user segments.

23. The system of claim 22, wherein the state machine is further configured to determine a selected impersonated user profile selected by the website visitor and update session information associated with the website visitor with a set of impersonated user segments corresponding to the selected impersonated user profile.

24. The system of claim 23, wherein the state machine is configured to allow the website visitor to apply multiple impersonated user profiles within a context of a single session.

25. The system of claim 22, wherein in the state machine is configured to maintain a set of session information associated with the website visitor comprising a set of visitor session data and a set of impersonated user data.

26. The system of claim 22, wherein the visitor session data comprises information about the website visitor and wherein the set of impersonated user data comprises a set of impersonated user segments.
